(19) United States
(12) Patent Application Publication
(10) Pub. No.: US 2018/0049237 A1
(43) Pub. Date: Feb. 15, 2018

(54) UPLINK RANDOM ACCESS METHOD AND RELATED DEVICE

(71) Applicant: HUAWEI TECHNOLOGIES CO., LTD., Shenzhen (CN)

(72) Inventors: Zhiheng GUO, Beijing (CN); Xizeng DAI, Beijing (CN); Xingqing CHENG, Beijing (CN)

(73) Assignee: HUAWEI TECHNOLOGIES CO., LTD., Shenzhen (CN)

(21) Appl. No.: 15/790,648

(22) Filed: Oct. 23, 2017

Related U.S. Application Data
(63) Continuation of application No. PCT/CN2015/077445, filed on Apr. 24, 2015.

(51) Int. Cl. H04W 74/00; H04W 52/24; H04L 27/26; H04W 28/18; H04J 11/00; H04W 72/04

(52) U.S. Cl. CPC H04W 74/004; H04J 11/0036; H04W 72/0446; H04L 27/2673; H04W 28/18; H04W 52/241

(57) ABSTRACT

Embodiments of the present invention provide an uplink random access method and a related device, thereby improving the success rate of uplink random access. The method includes: determining, by UE, K available root sequences for uplink random access according to a preset policy, where a maximum quantity of detection windows of single UE that can be supported by each of the K available root sequences is 2M+1, and maximum detection windows of the single UE that can be supported by each available root sequence do not overlap with each other, where K≧1, M is a detection window parameter, M>1, and both K and M are integers; and performing, by the UE, uplink random access according to the k^{th} available root sequence of the K available root sequences, where 1≦k≦K and k is an integer. The present invention is applicable to the field of wireless communications.

### CROSS-REFERENCE TO RELATED APPLICATIONS

This application is a continuation of International Application No. PCT/CN2015/077445, filed on Apr. 24, 2015, the disclosure of which is hereby incorporated by reference in its entirety.

### TECHNICAL FIELD

The present invention relates to the field of wireless communications, and in particular, to an uplink random access method and a related device.

### BACKGROUND

Generally, when user equipment (UE) performs uplink random access, the UE first performs, in a downlink direction, frequency synchronization with a base station. Due to the existence of an Doppler frequency offset, the UE is frequency locked on f+Δf, where Δf=f×v/c, f is a frequency at which the base station sends a carrier, Δf is a Doppler frequency offset, v is a carrier frequency, and c=3×10⁸ m/s. Therefore, when the UE sends an uplink random access signal, a frequency at which the UE sends a carrier is f+Δf. In consideration of a case in which another Doppler frequency offset is introduced due to movement of the UE in a process in which the uplink random access signal is propagated over the air, a frequency of the uplink random access signal that is sent by the UE and that is received by the base station is f+2Δf, that is, a frequency offset of 2Δf is generally introduced to a random access signal that is sent by the UE and that is received by the base station. Although in the prior art, in a design of a physical random access channel (PRACH) in a Long Term Evolution (LTE) system, a targeted design is made for a frequency offset problem of high-speed moving UE, the targeted design is generally applicable only to a relatively small frequency offset.

As wireless communications requirements continuously grow, users have increasingly high requirements on rates. Therefore, a larger bandwidth is required, and further, communication needs to be performed at a higher frequency. For example, communication needs to be performed at 5 GHz (hertz) or a frequency that is higher than 5 GHz. According to the foregoing Doppler frequency offset formula, a larger frequency offset is introduced. When the frequency offset is greater than a particular value, correlation peaks occur at multiple detection window locations after a local access sequence of the base station is correlated to a received access sequence of the base station. Because the targeted design in the prior art is generally applicable only to a relatively small frequency offset, when peaks occur at more detection windows, the base station considers that another UE performs access by using a different access sequence, leading to error detection on an uplink random access sequence, or a decrease in low estimation accuracy of a time delay of arrival of a received sequence. Consequently, a success rate of uplink random access by the UE is greatly decreased.

### SUMMARY

Embodiments of the present invention provide an uplink random access method, so as to resolve at least a problem in the prior art that a success rate of uplink random access when an uplink frequency offset is relatively large is greatly decreased, thereby improving the success rate of uplink random access when the uplink frequency offset is relatively large.

To achieve the foregoing objective, the following technical solutions are used in the embodiments of the present invention.

According to a first aspect, an uplink random access method is provided, where the method includes:

determining, by user equipment UE, K available root sequences for uplink random access according to a preset policy, where a maximum quantity of detection windows of single UE that can be supported by each of the K available root sequences is 2M+1, and maximum detection windows of the single UE that can be supported by each available root sequence do not overlap with each other, where K≧1, M is a detection window parameter, M>1, and both K and M are integers; and

performing, by the UE, uplink random access according to the k^{th} available root sequence of the K available root sequences, where 1≦k≦K and k is an integer.

With reference to the first aspect, in a first possible implementation of the first aspect, the preset policy includes:

a root sequence satisfying none of the following condition A, condition B, and condition C is an available root sequence:

the condition A: any detection window m∈{−M, . . . , M} of the single UE satisfies:

(m×dᵤ+N_{CS}−1)modN_{ZC}<(m×dᵤ)modN_{ZC};

the condition B: any detection windows mₐ and m_{b} of the single UE, where mₐ≠m_{b} and mₐ,m_{b}∈{−M,. . ., 0, . . . , M}, satisfy:

(mₐ×dᵤ)modN_{ZC}≦(m_{b}×dᵤ)modN_{ZC}, and

(mₐ×dᵤ+N_{CS}−1)modN_{ZC}≧(m_{b}×dᵤ)modN_{ZC; and}

the condition C: any detection windows mₐ and m_{b} of the single UE, where mₐ≠m_{b} and mₐ,m_{b}∈{−M, . . . , 0, . . ., M}, satisfy:

$$( {m}_{b} \times {d}_{u} + {N}_{CS} - 1 ) mod {N}_{ZC} \geq ( {m}_{a} \times {d}_{u} ) mod {N}_{ZC} , and ( {m}_{b} \times {d}_{u} + {N}_{CS} - 1 ) mod {N}_{ZC} \leq ( {m}_{a} \times {d}_{u} + {N}_{CS} - 1 ) mod {N}_{ZC} , \\ where {d}_{u} = \{ \begin{matrix} p & 0 \leq p \leq {N}_{ZC} / 2 \\ {N}_{ZC} - p & others\end{matrix} ;$$

p is a minimum non-negative integer satisfying (p×u)modN_{ZC}=1; u indicates a root sequence generation parameter; a root sequence is

$${x}_{u} ( n ) = {e}^{\frac{- jun ( n + 1 )}{{N}_{ZC}}} ;$$

is dᵤ indicates an offset of a peak generated when a subcarrier is shifted; N_{ZC} indicates a length of an uplink access root sequence; N_{CS} indicates a length of an uplink detection window; 2M+1 indicates the maximum quantity of detection windows of the single UE that can be supported by the available root sequence; m, mₐ, and m_{b} indicate any detection windows of the single UE; and mod indicates a modulo operation.

With reference to the first aspect or the first possible implementation of the first aspect, in a second possible implementation of the first aspect, after the determining, by UE, K available root sequences for uplink random access according to a preset policy, the method further includes:

determining, by the UE, start locations of cyclic shift sequences of the K available root sequences, where the start locations of the cyclic shift sequences of the K available root sequences include start locations of N cyclic shift sequences of the k^{th} available root sequence, the start locations of the N cyclic shift sequences include a start location of the n^{th} cyclic shift sequence, and N×(2M+1) detection windows corresponding to the start locations of the N cyclic shift sequences do not overlap with each other, where 1≦n≦N, N≧1, N indicates a quantity of cyclic shift sequences of the k^{th} available root sequence, and both n and N are integers; and

performing, by the UE, cyclic shift on the k^{th} available root sequence according to the start location of the n^{th} cyclic shift sequence, to obtain the n^{th} cyclic shift sequence of the k^{th} available root sequence, where magnitude of the cyclic shift is (d_{start,}_{ₙ}+a)modN_{ZC}; d_{start,}_{ₙ} is the start location of the n^{th} cyclic shift sequence; N_{ZC} indicates a length of an uplink access root sequence; mod indicates a modulo operation; and a is a preset integer value; and

the performing, by the UE, uplink random access according to the k^{th} available root sequence of the K available root sequences includes:

performing, by the UE, uplink random access according to the k^{th} available root sequence of the K available root sequences or the n^{th} cyclic shift sequence of the k^{th} available root sequence.

With reference to the second possible implementation of the first aspect, in a third possible implementation of the first aspect, a is prestored by the UE or is sent by the base station to the UE.

With reference to the second possible implementation of the first aspect or the third possible implementation of the first aspect, in a fourth possible implementation of the first aspect, the start location of the n^{th} cyclic shift sequence is obtained through calculation by using the following steps:

obtaining, by the UE, a start location of a detection window of the n^{th} cyclic shift sequence according to a first formula, where the first formula includes:

d_{start,}_{ₙ₁}=(d_{start,}_{ₙ}+m×dᵤ)modN_{ZC};

obtaining, by the UE, an end location of the detection window of the n^{th} cyclic shift sequence according to a second formula, where the second formula includes:

$${d}_{start {,}_{n 2}} = ( {d}_{start {,}_{n}} + m \times {d}_{u} + {N}_{CS} - 1 ) mod {N}_{ZC} , \\ where {d}_{start {,}_{1}} = 0 ; {d}_{start {,}_{n}} = {d}_{start {,}_{n - 1}} + {N}_{CS} ;$$

$${d}_{u} = \{ \begin{matrix} p & 0 \leq p \leq {N}_{ZC} / 2 \\ {N}_{ZC} - p & others\end{matrix} ;$$

p is a minimum non-negative integer satisfying (p×u)modN_{ZC}=1; dᵤ indicates an offset of a peak generated when a subcarrier is shifted; N_{ZC} indicates a length of an uplink access root sequence; N_{CS} indicates a length of an uplink detection window; d_{start,}_{ₙ₁} indicates the start location of the detection window of the n^{th} cyclic shift sequence; and d_{start,}_{ₙ₂} indicates the end location of the detection window of the n^{th} cyclic shift sequence;

determining, by the UE for any d_{start,}_{₁}∈v, whether a detection window corresponding to d_{start,}_{ₙ} and a detection window corresponding to d_{start,}_{₁} overlap, where v indicates a set of start locations of detection windows, and an initial set of v is v={d_{start,l}};

if the detection window corresponding to d_{start,}_{ₙ} and the detection window corresponding to d_{start,}_{ₗ} do not overlap, determining, by the UE, that the start location of the n^{th} cyclic shift sequence is d_{start,}_{ₙ} and adding d_{start,}_{ₙ} to v; and

if the detection window corresponding to d_{start,}_{ₙ} and the detection window corresponding to d_{start,}_{ₗ} overlap, assuming d_{start,}_{ₙ}=d_{start,}_{ₙ}1 and repeatedly performing, by the UE, the foregoing steps until d_{start,}_{ₙ}≧N_{ZC}−N_{CS}.

With reference to the fourth possible implementation of the first aspect, in a fifth possible implementation of the first aspect, a configuration parameter is prestored by the UE or is sent by the base station to the UE, where the configuration parameter includes at least one of the following parameters: M, N_{ZC}, or N_{CS}.

With reference to any one of the first aspect to the fifth possible implementation of the first aspect, in a sixth possible implementation of the first aspect, before the performing, by the UE, uplink random access according to the k^{th} available root sequence of the K available root sequences, the method further includes:

receiving, by the UE, a physical random access channel PRACH time-frequency resource sent by the base station, where the PRACH time-frequency resource and a PRACH time-frequency resource that is configured by the base station for the UE when M=1 are configured independently; and

the performing, by the UE, uplink random access according to the k^{th} available root sequence of the K available root sequences includes:

performing, by the UE, uplink random access on the PRACH according to the k^{th} available root sequence of the K available root sequences.

With reference to any one of the first aspect to the sixth possible implementation of the first aspect, in a seventh possible implementation of the first aspect, after the determining, by UE, K available root sequences for uplink random access according to a preset policy and before the performing, by the UE, uplink random access according to the k^{th} available root sequence of the K available root sequences, the method further includes:

receiving, by the UE, a sequence number of an initial sequence and a quantity Q of random access sequences supported by a cellular cell that are sent by the base station, where Q≧1 and Q is an integer; and

determining, by the UE, an initial available root sequence in the K available root sequences according to the sequence number; and

the performing, by the UE, uplink random access according to the k^{th} available root sequence of the K available root sequences includes:

performing, by the UE, uplink random access according to the initial available root sequence or any one of available root sequence of Q−1 available sequences after the initial available root sequence.

According to a second aspect, user equipment UE is provided, where the UE includes: a determining unit and an access unit, where

the determining unit is configured to determine K available root sequences for uplink random access according to a preset policy, where a maximum quantity of detection windows of single UE that can be supported by each of the K available root sequences is 2M+1, and maximum detection windows of the single UE that can be supported by each available root sequence do not overlap with each other, where K≧1, M is a detection window parameter, M>1, and both K and M are integers; and

the access unit is configured to perform uplink random access according to the k^{th} available root sequence of the K available root sequences, where 1≦k≦K and k is an integer.

With reference to the second aspect, in a first possible implementation of the second aspect, the preset policy includes:

a root sequence satisfying none of the following condition A, condition B, and condition C is an available root sequence:

the condition A: any detection window m∈{−M, . . . , 0, . . . , M} of the single UE satisfies:

(m×dᵤ+N_{CS}−1)mod N_{ZC}<(m×dᵤ)modN_{ZC};

the condition B: any detection windows mₐ and m_{b} of the single UE, where mₐ≠m_{b} and mₐ,m_{b}∈{−M, . . . , 0, . . . , M}, satisfy:

(mₐ×dᵤ)modN_{ZC}≦(m_{b}×dᵤ)mod N_{ZC}, and

(mₐ×dᵤ+N_{CS}−1)modN_{ZC}≧(m_{b}×dᵤ)modN_{ZC}; and

the condition C: any detection windows mₐ and m_{b} of the single UE, where mₐ≠m_{b} and mₐ,m_{b}∈{−M, . . . , 0, . . . , M}, satisfy:

$$( {m}_{b} \times {d}_{u} + {N}_{CS} - 1 ) mod {N}_{ZC} \geq ( {m}_{a} \times {d}_{u} ) mod {N}_{ZC} , and ( {m}_{b} \times {d}_{u} + {N}_{CS} - 1 ) mod {N}_{ZC} \leq ( {m}_{a} \times {d}_{u} + {N}_{CS} - 1 ) mod {N}_{ZC} , \\ where {d}_{u} = \{ \begin{matrix} p & 0 \leq p \leq {N}_{ZC} / 2 \\ {N}_{ZC} - p & others\end{matrix} ,$$

p is a minimum non-negative integer satisfying (p×u)modN_{ZC}=1; u indicates a root sequence generation parameter; a root sequence is

$${x}_{u} ( n ) = {e}^{\frac{- jun ( n + 1 )}{{N}_{ZC}}} ;$$

dᵤ indicates an offset of a peak generated when a subcarrier is shifted; N_{ZC} indicates a length of an uplink access root sequence; N_{CS} indicates a length of an uplink detection window; 2M+1 indicates the maximum quantity of detection windows of the single UE that can be supported by the available root sequence; m, mₐ, and m_{b} indicate any detection windows of the single UE; and mod indicates a modulo operation.

With reference to the second aspect or the first possible implementation of the second aspect, in a second possible implementation of the second aspect, the UE further includes a generation unit, where

the determining unit is further configured to: after determining the K available root sequences for uplink random access according to the preset policy, determine start locations of cyclic shift sequences of the K available root sequences, where the start locations of the cyclic shift sequences of the K available root sequences include start locations of N cyclic shift sequences of the k^{th} available root sequence, the start locations of the N cyclic shift sequences include a start location of the n^{th} cyclic shift sequence, and N×(2M+1) detection windows corresponding to the start locations of the N cyclic shift sequences do not overlap with each other, where 1≦n≦N, N≧1, N indicates a quantity of cyclic shift sequences of the k^{th} available root sequence, and both n and N are integers;

the generation unit is configured to perform cyclic shift on the k^{th}available root sequence according to the start location of the n^{th} cyclic shift sequence, to obtain the n^{th} cyclic shift sequence of the k^{th} available root sequence, where magnitude of the cyclic shift is (d_{start,}_{ₙ}+a)modN_{ZC}; d_{start,}_{ₙ} is the start location of the n^{th} cyclic shift sequence; N_{ZC} indicates a length of an uplink access root sequence; mod indicates a modulo operation; and a is a preset integer value; and

the access unit is specifically configured to:

perform uplink random access according to the k^{th} available root sequence of the K available root sequences or the n^{th} cyclic shift sequence of the k^{th} available root sequence.

With reference to the second possible implementation of the second aspect, in a third possible implementation of the second aspect, a is prestored by the UE or is sent by the base station to the UE.

With reference to the second possible implementation of the second aspect or the third possible implementation of the second aspect, in a fourth possible implementation of the second aspect, the determining unit is specifically configured to:

obtain a start location of a detection window of the n^{th} cyclic shift sequence according to a first formula, where the first formula includes:

d_{start,}_{ₙ₁}=(d_{start,}_{ₙ}+m×dᵤ)modN_{ZC};

obtain an end location of the detection window of the n^{th} cyclic shift sequence according to a second formula, where the second formula includes:

$${d}_{start {,}_{n 2}} = ( {d}_{start {,}_{n}} + m \times {d}_{u} + {N}_{CS} - 1 ) mod {N}_{ZC} , \\ where {d}_{start {,}_{1}} = 0 ; {d}_{start {,}_{n}} = {d}_{start {,}_{n - 1}} + {N}_{CS} ;$$

$${d}_{u} = \{ \begin{matrix} p & 0 \leq p \leq {N}_{ZC} / 2 \\ {N}_{ZC} - p & others\end{matrix} ;$$

p is a minimum non-negative integer satisfying (p×u)modN_{ZC}=1; dᵤ indicates an offset of a peak generated when a subcarrier is shifted; N_{ZC} indicates a length of an uplink access root sequence; N_{CS} indicates a length of an uplink detection window; d_{start,}_{ₙ₁} indicates the start location of the detection window of the n^{th} cyclic shift sequence; and d_{start,}_{ₙ₂} indicates the end location of the detection window of the n^{th} cyclic shift sequence;

determine, for any d_{start,}_{ₗ}∈v, whether a detection window corresponding to d_{start,}_{ₙ} and a detection window corresponding to d_{start,}_{ₗ} overlap, where v indicates a set of start locations of detection windows, and an initial set of v is v={d_{start,l}};
if the detection window corresponding to d_{start,}_{ₙ} and the detection window corresponding to d_{start,}_{ₗ} do not overlap, determine that the start location of the n^{th} cyclic shift sequence is d_{start,}_{ₙ} and add d_{start,}_{ₙ} to v; and

if the detection window corresponding to d_{start,}_{ₙ} and the detection window corresponding to d_{start,}_{ₗ} overlap, assume d_{start,}_{ₙ}=d_{start,}_{ₙ}+1 and repeatedly perform the foregoing steps until d_{start,}_{ₙ}≧N_{ZC}−N_{CS}.

With reference to the fourth possible implementation of the second aspect, in a fifth possible implementation of the second aspect, a configuration parameter is prestored by the UE or is sent by the base station to the UE, where the configuration parameter includes at least one of the following parameters: M, N_{ZC}, or N_{CS}.

With reference to any one of the second aspect to the fifth possible implementation of the second aspect, in a sixth possible implementation of the second aspect, the UE further includes a receiving unit, where

the receiving unit is configured to: before the access unit performs uplink random access according to the k^{th} available root sequence of the K available root sequences, receive a physical random access channel PRACH time-frequency resource sent by the base station, where the PRACH time-frequency resource and a PRACH time-frequency resource that is configured by the base station for the UE when M=1 are configured independently; and

the access unit is specifically configured to:

perform uplink random access on the PRACH according to the k^{th} available root sequence of the K available root sequences.

With reference to any one of the second aspect to the fifth possible implementation of the second aspect, in a seventh possible implementation of the second aspect, the UE further includes a receiving unit, where

the receiving unit is configured to: after the determining unit determines the K available root sequences for uplink random access according to the preset policy and before the access unit performs uplink random access according to the k^{th} available root sequence of the K available root sequences, receive a sequence number of an initial sequence and a quantity Q of random access sequences supported by a cellular cell that are sent by the base station, where Q≧1 and Q is an integer;

the determining unit is further configured to determine an initial available root sequence in the K available root sequences according to the sequence number; and

the access unit is specifically configured to:

perform uplink random access according to the initial available root sequence or any one of available root sequence of Q−1 available sequences after the initial available root sequence.

Based on the uplink random access method and the UE that are provided in the embodiments of the present invention, in the embodiments of the present invention, a maximum quantity of detection windows of single UE that can be supported by each available root sequence for uplink random access and that is determined by the UE according to a preset policy is 2M+1, where M>1. That is, the maximum quantity of detection windows of the single UE that can be supported by each available root sequence for uplink random access and that is determined by the UE is at least five, and maximum detection windows that can be supported by each available root sequence do not overlap with each other, thereby avoiding a problem in the prior art that a success rate of uplink random access by UE is greatly decreased because a targeted design is generally applicable only to a relatively small frequency offset, for example, a maximum quantity of detection windows that can be supported by an available root sequence for uplink random access is three; when the frequency offset is greater than a particular value, correlation peaks occur at multiple detection window locations after a local access sequence is correlated to a received access sequence, but a base station accesses the UE with a relatively large success rate when peaks occur at a maximum of three detection windows. In the embodiments of the present invention, the UE determines K available root sequences for uplink random access, where the maximum quantity of detection windows of the single UE that can be supported by each of the K available root sequences becomes larger. Therefore, when a frequency offset is greater than a particular value, and when correlation peaks occur at multiple locations after a local access sequence is correlated to a received access sequence, a base station can access the UE with a relatively large success rate when peaks occur at more detection windows, thereby improving a success rate of uplink random access when an uplink frequency offset is relatively large.

According to a third aspect, an uplink random access method is provided, where the method includes:

determining, by a base station, K available root sequences for uplink random access according to a preset policy, where a maximum quantity of detection windows of single UE that can be supported by each of the K available root sequences is 2M+1, and maximum detection windows of the single UE that can be supported by each available root sequence do not overlap with each other, where K≧1, M is a detection window parameter, M>1, and both K and M are integers; and

performing, by the base station, uplink random access detection according to the k^{th} available root sequence of the K available root sequences, where 1≦k≦K and k is an integer.

With reference to the third aspect, in a first possible implementation of the third aspect, the preset policy includes:

a root sequence satisfying none of the following condition A, condition B, and condition C is an available root sequence:

the condition A: any detection window m∈{−M, . . . , 0, . . . , M} of the single UE satisfies:

(m×dᵤ+N_{CS}−1)modN_{ZC}<(m×dᵤ)modN_{ZC};

the condition B: any detection windows mₐ and m_{b} of the single UE, where mₐ≠m_{b} and mₐ,m_{b}∈{−M, . . . , 0, . . ., M}, satisfy:

(mₐ×dᵤ)modN_{ZC}≦(m_{b}×dᵤ)modN_{ZC}, and

(mₐ×dᵤ+N_{CS}−1)modN_{ZC}≧(m_{b}×dᵤ)modN_{ZC}; and

the condition C: any detection windows mₐ and m_{b} of the single UE, where mₐ≠m_{b} and mₐ,m_{b}∈{−M, . . . , 0, . . . , M}, satisfy:

$$( {m}_{b} \times {d}_{u} + {N}_{CS} - 1 ) mod {N}_{ZC} \geq ( {m}_{a} \times {d}_{u} ) mod {N}_{ZC} , and ( {m}_{b} \times {d}_{u} + {N}_{CS} - 1 ) mod {N}_{ZC} \leq ( {m}_{a} \times {d}_{u} + {N}_{CS} - 1 ) mod {N}_{ZC} , \\ where {d}_{u} = \{ \begin{matrix} p & 0 \leq p \leq {N}_{ZC} / 2 \\ {N}_{ZC} - p & others\end{matrix} ;$$

p is a minimum non-negative integer satisfying (p×u)modN_{ZC}=1; u indicates a root sequence generation parameter; a root sequence is

$${x}_{u} ( n ) = {e}^{\frac{- jun ( n + 1 )}{{N}_{ZC}}} ;$$

is dᵤ indicates an offset of a peak generated when a subcarrier is shifted; N_{ZC} indicates a length of an uplink access root sequence; N_{CS} indicates a length of an uplink detection window; 2M+1 indicates the maximum quantity of detection windows of the single UE that can be supported by the available root sequence; m, mₐ and m_{b} indicate any detection windows of the single UE; and mod indicates a modulo operation.

With reference to the third aspect or the first possible implementation of the third aspect, in a second possible implementation of the third aspect, after the determining, by a base station, K available root sequences for uplink random access according to a preset policy, the method further includes:

determining, by the base station, start locations of cyclic shift sequences of the K available root sequences, where the start locations of the cyclic shift sequences of the K available root sequences include start locations of N cyclic shift sequences of the k^{th} available root sequence, the start locations of the N cyclic shift sequences include a start location of the n^{th} cyclic shift sequence, and N×(2M+1) detection windows corresponding to the start locations of the N cyclic shift sequences do not overlap with each other, where 1≦n≦N, N≧1, N indicates a quantity of cyclic shift sequences of the k^{th} available root sequence, and both n and N are integers; and

performing, by the base station, cyclic shift on the k^{th} available root sequence according to the start location of the n^{th} cyclic shift sequence, to obtain the n^{th} cyclic shift sequence of the k^{th} available root sequence, where magnitude of the cyclic shift is (d_{start,}_{ₙ}+a)modN_{ZC}; d_{start,}_{ₙ} is the start location of the n^{th} cyclic shift sequence; N_{ZC} indicates a length of an uplink access root sequence; mod indicates a modulo operation; and a is a preset integer value; and

the performing, by the base station, uplink random access detection according to the k^{th} available root sequence of the K available root sequences includes:

performing, by the base station, uplink random access detection according to the k^{th} available root sequence of the K available root sequences or the n^{th} cyclic shift sequence of the k^{th} available root sequence.

With reference to the second possible implementation of the third aspect, in a third possible implementation of the third aspect, the start location of the n^{th} cyclic shift sequence is obtained through calculation by using the following steps:

obtaining, by the base station, a start location of a detection window of the n^{th} cyclic shift sequence according to a first formula, where the first formula includes:

d_{start,}_{ₙ₁}=(d_{start,}_{ₙ}+m×dᵤ)modN_{ZC};

obtaining, by the UE, an end location of the detection window of the n^{th} cyclic shift sequence according to a second formula, where the second formula includes:

$${d}_{start {,}_{n 2}} = ( {d}_{start {,}_{n}} + m \times {d}_{u} + {N}_{CS} - 1 ) mod {N}_{ZC} , \\ where {d}_{start {,}_{1}} = 0 ; {d}_{start {,}_{n}} = {d}_{start {,}_{n - 1}} + {N}_{CS} ;$$

$${d}_{u} = \{ \begin{matrix} p & 0 \leq p \leq {N}_{ZC} / 2 \\ {N}_{ZC} - p & others\end{matrix} ;$$

p is a minimum non-negative integer satisfying (p×u)modN_{ZC}=1; dᵤ indicates an offset of a peak generated when a subcarrier is shifted; N_{ZC} indicates a length of an uplink access root sequence; N_{CS} indicates a length of an uplink detection window; d_{start,}_{ₙ₁} indicates the start location of the detection window of the n^{th} cyclic shift sequence; and d_{start,}_{ₙ₂} indicates the end location of the detection window of the n^{th} cyclic shift sequence;

determining, by the UE for any d_{start.}_{ₗ}∈v, whether a detection window corresponding to d_{start,}_{ₙ} and a detection window corresponding to d_{start,}_{ₙ} overlap, where v indicates a set of start locations of detection windows, and an initial set of v is v={d_{start,l}};

if the detection window corresponding to d_{start,}_{ₙ} and the detection window corresponding to d_{start,}_{ₗ} do not overlap, determining, by the UE, that the start location of the n^{th} cyclic shift sequence is d_{start,}_{ₙ} and adding d_{start,}_{ₙ} to v; and

if the detection window corresponding to d_{start,}_{ₙ} and the detection window corresponding to d_{start,}_{ₗ} overlap, assuming d_{start,}_{ₙ}=d_{start,}_{ₙ}+1 and repeatedly performing, by the UE, the foregoing steps until d_{start,}_{ₙ}≧N_{ZC}−N_{CS}.

With reference to any one of the third aspect to the third possible implementation of the third aspect, in a fourth possible implementation of the third aspect, before the performing, by the base station, uplink random access detection according to the k^{th} available root sequence of the K available root sequences, the method further includes:

sending, by the base station, a physical random access channel PRACH time-frequency resource to user equipment UE, where the PRACH time-frequency resource and a PRACH time-frequency resource that is configured by the base station for the UE when M=1 are configured independently; and

the performing, by the base station, uplink random access detection according to the k^{th} available root sequence of the K available root sequences includes:

performing, by the base station, uplink random access detection on the PRACH according to the k^{th} available root sequence of the K available root sequences.

With reference to any one of the third aspect to the fourth possible implementation of the third aspect, in a fifth possible implementation of the third aspect, after the determining, by a base station, K available root sequences for uplink random access according to a preset policy and before the performing, by the base station, uplink random access detection according to the k^{th} available root sequence of the K available root sequences, the method further includes:

sending, by the base station, a sequence number of an initial sequence and a quantity Q of random access sequences supported by a cellular cell to the UE, where Q≧1 and Q is an integer; and

determining, by the base station, an initial available root sequence in the K available root sequences according to the sequence number; and

the performing, by the base station, uplink random access detection according to the k^{th} available root sequence of the K available root sequences includes:

performing, by the base station, uplink random access detection according to the initial available root sequence or any one of Q−1 available root sequences after the initial available root sequence.

With reference to any one of the third aspect to the fourth possible implementation of the third aspect, in a sixth possible implementation of the third aspect, after the determining, by a base station, K available root sequences for uplink random access according to a preset policy and before the performing, by the base station, uplink random access detection according to the k^{th} available root sequence of the K available root sequences, the method further includes:

determining, by the base station, whether Q consecutive available root sequences exist in the K available root sequences, where Q is a quantity of random access sequences supported by a cellular cell, 1≦Q≦K, and Q is an integer; and

if the Q consecutive available root sequences exist, sending, by the base station, a sequence number of an initial available root sequence and a configuration message to the UE, where the sequence number of the initial available root sequence is a sequence number of the first available root sequence of the Q consecutive available root sequences, and the configuration message is used to indicate that N_{CS} supports a non-limited set and N_{CS} is configured to 0, where N_{CS} indicates a length of an uplink detection window.

According to a fourth aspect, a base station is provided, where the base station includes: a determining unit and a detection unit, where

the determining unit is configured to determine K available root sequences for uplink random access according to a preset policy, where a maximum quantity of detection windows of single UE that can be supported by each of the K available root sequences is 2M+1, and maximum detection windows of the single UE that can be supported by each available root sequence do not overlap with each other, where K≧1, M is a detection window parameter, M>1, and both K and M are integers; and

the detection unit is configured to perform uplink random access detection according to the k^{th} available root sequence of the K available root sequences, where 1≦k≦K and k is an integer.

With reference to the fourth aspect, in a first possible implementation of the fourth aspect, the preset policy includes:

a root sequence satisfying none of the following condition A, condition B, and condition C is an available root sequence:

the condition A: any detection window m∈{−M, . . . , 0, . . . , M} of the single UE satisfies:

(m×dᵤ+N_{CS}−1)modN_{ZC}<(m×dᵤ)modN_{ZC};

the condition B: any detection windows mₐ and m_{b} of the single UE, where mₐ≠m_{b} and mₐ, m_{b}∈{−M, . . . , 0, . . . , M}, satisfy:

(mₐ×dᵤ)modN_{ZC}≦(m_{b}×dᵤ)modN_{ZC}, and

(mₐ×dᵤ+N_{CS}−1)modN_{ZC}≧(m_{b}×dᵤ)modN_{ZC}; and

the condition C: any detection windows mₐ and m_{b} of the single UE, where mₐ≠m_{b} and mₐ, m_{b}∈{−M, . . . , 0, . . . , M}, satisfy:

$$( {m}_{b} \times {d}_{u} + {N}_{CS} - 1 ) mod {N}_{ZC} \geq ( {m}_{a} \times {d}_{u} ) mod {N}_{ZC} , and ( {m}_{b} \times {d}_{u} + {N}_{CS} - 1 ) mod {N}_{ZC} \leq ( {m}_{a} \times {d}_{u} + {N}_{CS} - 1 ) mod {N}_{ZC} , \\ where {d}_{u} = \{ \begin{matrix} p & 0 \leq p \leq {N}_{ZC} / 2 \\ {N}_{ZC} - p & others\end{matrix} ;$$

p is a minimum non-negative integer satisfying (p×u)modN_{ZC}=1; u indicates a root sequence generation parameter; a root sequence is

$${x}_{u} ( n ) = {e}^{\frac{- jun ( n + 1 )}{{N}_{ZC}}} ;$$

dᵤ indicates an offset of a peak generated when a subcarrier is shifted; N_{ZC} indicates a length of an uplink access root sequence; N_{CS} indicates a length of an uplink detection window; 2M+1 indicates the maximum quantity of detection windows of the single UE that can be supported by the available root sequence; m, mₐ, and m_{b} indicate any detection windows of the single UE; and mod indicates a modulo operation.

With reference to the fourth aspect or the first possible implementation of the fourth aspect, in a second possible implementation of the fourth aspect, the base station further includes a generation unit, where

the determining unit is further configured to: after determining the K available root sequences for uplink random access according to the preset policy, determine start locations of cyclic shift sequences of the K available root sequences, where the start locations of the cyclic shift sequences of the K available root sequences include start locations of N cyclic shift sequences of the k^{th} available root sequence, the start locations of the N cyclic shift sequences include a start location of the n^{th} cyclic shift sequence, and N×(2M+1) detection windows corresponding to the start locations of the N cyclic shift sequences do not overlap with each other, where 1≦n≦N, N≧1, N indicates a quantity of cyclic shift sequences of the k^{th} available root sequence, and both n and N are integers;

the generation unit is configured to perform cyclic shift on the k^{th} available root sequence according to the start location of the n^{th} cyclic shift sequence, to obtain the n^{th} cyclic shift sequence of the k^{th} available root sequence, where magnitude of the cyclic shift is (d_{start,}_{ₙ}+a)modN_{ZC}; d_{start,}_{ₙ} is the start location of the n^{th} cyclic shift sequence; N_{ZC} indicates a length of an uplink access root sequence; mod indicates a modulo operation; and a is a preset integer value; and

the detection unit is specifically configured to:

perform uplink random access detection according to the k^{th} available root sequence of the K available root sequences or the n^{th} cyclic shift sequence of the k^{th} available root sequence.

With reference to the second possible implementation of the fourth aspect, in a third possible implementation of the fourth aspect, the determining unit is specifically configured to:

obtain a start location of a detection window of the n^{th} cyclic shift sequence according to a first formula, where the first formula includes:

d_{start,}_{ₙ₁}=(d_{start,}_{ₙ}+m×dᵤ)modN_{ZC};

obtain an end location of the detection window of the n^{th} cyclic shift sequence according to a second formula, where the second formula includes:

$${d}_{start {,}_{n 2}} = ( {d}_{start {,}_{n}} + m \times {d}_{u} + {N}_{CS} - 1 ) mod {N}_{ZC} , \\ where {d}_{start {,}_{1}} = 0 ; {d}_{start {,}_{n}} = {d}_{start {,}_{n - 1}} + {N}_{CS} ;$$

$${d}_{u} = \{ \begin{matrix} p & 0 \leq p \leq {N}_{ZC} / 2 \\ {N}_{ZC} - p & others\end{matrix} ;$$

p is a minimum non-negative integer satisfying (p×u)modN_{ZC}=1; dᵤ indicates an offset of a peak generated when a subcarrier is shifted; N_{ZC} indicates a length of an uplink access root sequence; N_{CS} indicates a length of an uplink detection window; d_{start,}_{ₙ₁} indicates the start location of the detection window of the n^{th} cyclic shift sequence; and d_{start,}_{ₙ₂} indicates the end location of the detection window of the n^{th} cyclic shift sequence;

determine, for any d_{start,}_{₁}∈v, whether a detection window corresponding to d_{start,}_{ₙ} and a detection window corresponding to d_{start,}_{ₗ} overlap, where v indicates a set of start locations of detection windows, and an initial set of v is v={d_{start,l}};

if the detection window corresponding to d_{start,}_{ₙ} and the detection window corresponding to d_{start,}_{ₗ} do not overlap, determine that the start location of the n^{th} cyclic shift sequence is d_{start,}_{ₙ} and add d_{start,}_{ₙ} to v; and

if the detection window corresponding to d_{start,}_{ₙ} and the detection window corresponding to d_{start,}_{ₗ} overlap, assume d_{start,}_{ₙ}=d_{start,}_{ₙ}+1 and repeatedly perform the foregoing steps until d_{start,}_{ₙ}≧N_{ZC}−N_{CS}.

With reference to any one of the fourth aspect to the third possible implementation of the fourth aspect, in a fourth possible implementation of the fourth aspect, the base station further includes a sending unit, where

the sending unit is configured to: before the detection unit performs uplink random access detection according to the k^{th} available root sequence of the K available root sequences, send a physical random access channel PRACH time-frequency resource to user equipment UE, where the PRACH time-frequency resource and a PRACH time-frequency resource that is configured by the base station for the UE when M=1 are configured independently; and

the detection unit is specifically configured to:

perform uplink random access detection on the PRACH according to the k^{th} available root sequence of the K available root sequences.

With reference to any one of the fourth aspect to the third possible implementation of the fourth aspect, in a fifth possible implementation of the fourth aspect, the base station further includes a sending unit, where

the sending unit is configured to: after the determining unit determines the K available root sequences for uplink random access according to the preset policy and before the detection unit performs uplink random access detection according to the k^{th} available root sequence of the K available root sequences, send a sequence number of an initial sequence and a quantity Q of random access sequences supported by a cellular cell to the UE, where Q≧1 and Q is an integer;

the determining unit is further configured to determine an initial available root sequence in the K available root sequences according to the sequence number; and

the detection unit is specifically configured to:

perform uplink random access detection according to the initial available root sequence or any one of Q−1 available root sequences after the initial available root sequence.

With reference to any one of the fourth aspect to the third possible implementation of the fourth aspect, in a sixth possible implementation of the fourth aspect, the base station further includes a sending unit, where

the determining unit is further configured to: after the determining unit determines the K available root sequences for uplink random access according to the preset policy and before the detection unit performs uplink random access detection according to the k^{th} available root sequence of the K available root sequences, determine whether Q consecutive available root sequences exist in the K available root sequences, where Q is a quantity of random access sequences supported by a cellular cell, 1≦Q≦K, and Q is an integer; and

the sending unit is configured to: if the Q consecutive available root sequences exist, send a sequence number of an initial available root sequence and a configuration message to the UE, where the sequence number of the initial available root sequence is a sequence number of the first available root sequence of the Q consecutive available root sequences, and the configuration message is used to indicate that N_{CS} supports a non-limited set and N_{CS} is configured to 0, where N_{CS} indicates a length of an uplink detection window.

Based on the uplink random access method and the base station that are provided in the embodiments of the present invention, in the embodiments of the present invention, a maximum quantity of detection windows of single UE that can be supported by each available root sequence for uplink random access and that is determined by the base station according to a preset policy is 2M+1, where M>1. That is, the maximum quantity of detection windows of the single UE that can be supported by each available root sequence for uplink random access and that is determined by the base station is at least five, and maximum detection windows that can be supported by each available root sequence do not overlap with each other, thereby avoiding a problem in the prior art that a success rate of uplink random access by UE is greatly decreased because a targeted design is generally applicable only to a relatively small frequency offset, for example, a maximum quantity of detection windows that can be supported by an available root sequence for uplink random access is three, and when the frequency offset is greater than a particular value, correlation peaks occur at multiple detection window locations after a local access sequence is correlated to a received access sequence, but a base station accesses the UE with a relatively large success rate when peaks occur at a maximum of three detection windows. In the embodiments of the present invention, the base station determines K available root sequences for uplink random access, where the maximum quantity of detection windows of the single UE that can be supported by each of the K available root sequences becomes larger. Therefore, when a frequency offset is greater than a particular value, and when correlation peaks occur at multiple locations after a local access sequence is correlated to a received access sequence, the base station can access the UE with a relatively large success rate when peaks occur at more detection windows, thereby improving a success rate of uplink random access when an uplink frequency offset is relatively large.

According to a fifth aspect, an uplink random access method is provided, where the method includes:

receiving, by user equipment UE, a sequence number of an initial available root sequence and a configuration message that are sent by a base station, where a maximum quantity of detection windows of single UE that can be supported by the initial available root sequence is 2M+1, maximum detection windows of the single UE that can be supported by the initial available root sequence do not overlap with each other, and the configuration message is used to indicate that N_{CS} supports a non-limited set and N_{CS} is configured to 0, where N_{CS} indicates a length of an uplink detection window, M is a detection window parameter, M>1, and M is an integer; and

performing, by the UE according to the sequence number and the configuration message, random access on the initial available root sequence or any one of Q−1 consecutive available root sequences after the initial available root sequence, where a maximum quantity of detection windows of the single UE that can be supported by any one of the Q−1 root sequences is 2M+1, and maximum detection windows of the single UE that can be supported by any one of the Q−1 root sequences do not overlap with each other, where Q is a quantity of random access sequences supported by a cellular cell, Q≧1, and Q is an integer.

According to a sixth aspect, user equipment UE is provided, where the UE includes: a receiving unit and an access unit, where

the receiving unit is configured to receive a sequence number of an initial available root sequence and a configuration message that are sent by a base station, where a maximum quantity of detection windows of single UE that can be supported by the initial available root sequence is 2M+1, maximum detection windows of the single UE that can be supported by the initial available root sequence do not overlap with each other, and the configuration message is used to indicate that N_{CS} supports a non-limited set and N_{CS} is configured to 0, where N_{CS} indicates a length of an uplink detection window, M is a detection window parameter, M>1, and M is an integer; and

the access unit is configured to perform, according to the sequence number and the configuration message, random access on the initial available root sequence or any one of Q−1 consecutive available root sequences after the initial available root sequence, where a maximum quantity of detection windows of the single UE that can be supported by any one of the Q−1 root sequences is 2M+1, and maximum detection windows of the single UE that can be supported by any one of the Q−1 root sequences do not overlap with each other, where Q is a quantity of random access sequences supported by a cellular cell, Q≧1, and Q is an integer.

Based on the uplink random access method and the UE that are provided in the embodiments of the present invention, on one hand, a maximum quantity of detection windows of single UE that can be supported by an initial available root sequence or any one of Q−1 consecutive available root sequences after the initial available root sequence is 2M+1, where M>1. That is, the maximum quantity of detection windows of the single UE that can be supported by each available root sequence is at least five, and maximum detection windows that can be supported by each available root sequence do not overlap with each other, thereby avoiding a problem in the prior art that a success rate of uplink random access by UE is greatly decreased because a targeted design is generally applicable only to a relatively small frequency offset, for example, a maximum quantity of detection windows that can be supported by an available root sequence for uplink random access is three, and when the frequency offset is greater than a particular value, correlation peaks occur at multiple detection window locations after a local access sequence is correlated to a received access sequence, but a base station accesses the UE with a relatively large success rate when peaks occur at a maximum of three detection windows. In the embodiments of the present invention, a base station sends an initial available root sequence or Q−1 consecutive available root sequences after the initial available root sequence, where the maximum quantity of detection windows of the single UE that can be supported by each available root sequence becomes larger. Therefore, when a frequency offset is greater than a particular value, and when correlation peaks occur at multiple locations after a local access sequence is correlated to a received access sequence, the base station can access the UE with a relatively large success rate when peaks occur at more detection windows, thereby improving a success rate of uplink random access when an uplink frequency offset is relatively large. On the other hand, a configuration message sent by the base station indicates that N_{CS} supports a non-limited set and N_{CS}=0, that is, it is represented that available root sequences determined when M=1 and these available root sequences overlap. Therefore, low-version UE is allowed to perform uplink random access by using these available root sequences, thereby better achieving backward compatibility.

According to a seventh aspect, user equipment UE is provided, where the UE includes a processor, a memory, a bus, and a communications interface, where

the memory is configured to store a computer execution instruction, the processor is connected to the memory by using the bus, and when the UE is running, the processor executes the computer execution instruction that is stored in the memory to enable the UE to perform the uplink random access method according to any one of the possible implementations of the first aspect or the uplink random access method according to the fifth aspect.

Because the UE provided in this embodiment of the present invention can perform the uplink random access method according to any one of the possible implementations of the first aspect or the uplink random access method according to the fifth aspect, for technical effects that can be achieved by the UE, refer to the foregoing embodiments, and details are not described herein again.

According to an eighth aspect, a base station is provided, where the base station includes a processor, a memory, a bus, and a communications interface, where

the memory is configured to store a computer execution instruction, the processor is connected to the memory by using the bus, and when the base station is running, the processor executes the computer execution instruction that is stored in the memory to enable the base station to perform the uplink random access method according to any one of the possible implementations of the third aspect.

Because the base station provided in this embodiment of the present invention can perform the uplink random access method according to any one of the possible implementations of the third aspect, for technical effects that can be achieved by the base station, refer to the foregoing embodiments, and details are not described herein again.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a first schematic flowchart of an uplink random access method according to an embodiment of the present invention;

FIG. 2 is a second schematic flowchart of an uplink random access method according to an embodiment of the present invention;

FIG. 3 is a third schematic flowchart of an uplink random access method according to an embodiment of the present invention;

FIG. 4 is a fourth schematic flowchart of an uplink random access method according to an embodiment of the present invention;

FIG. 5 is a fifth schematic flowchart of an uplink random access method according to an embodiment of the present invention;

FIG. 6 is a sixth schematic flowchart of an uplink random access method according to an embodiment of the present invention;

FIG. 7 is a seventh schematic flowchart of an uplink random access method according to an embodiment of the present invention;

FIG. 8 is an eighth schematic flowchart of an uplink random access method according to an embodiment of the present invention;

FIG. 9 is a ninth schematic flowchart of an uplink random access method according to an embodiment of the present invention;

FIG. 10 is a tenth schematic flowchart of an uplink random access method according to an embodiment of the present invention;

FIG. 11 is a first schematic structural diagram of UE according to an embodiment of the present invention;

FIG. 12 is a second schematic structural diagram of UE according to an embodiment of the present invention;

FIG. 13 is a third schematic structural diagram of UE according to an embodiment of the present invention;

FIG. 14 is a fourth schematic structural diagram of UE according to an embodiment of the present invention;

FIG. 15 is a first schematic structural diagram of a base station according to an embodiment of the present invention;

FIG. 16 is a second schematic structural diagram of a base station according to an embodiment of the present invention;

FIG. 17 is a third schematic structural diagram of a base station according to an embodiment of the present invention;

FIG. 18 is a fourth schematic structural diagram of a base station according to an embodiment of the present invention;

FIG. 19 is a fifth schematic structural diagram of UE according to an embodiment of the present invention;

FIG. 20 is a first schematic architectural diagram of an uplink random access system according to an embodiment of the present invention; and

FIG. 21 is a second schematic architectural diagram of an uplink random access system according to an embodiment of the present invention.

### DESCRIPTION OF EMBODIMENTS

To clearly and briefly describe the following embodiments, formulas, inequalities, and related definitions of parameters in the formulas and the inequalities in the embodiments of the present invention are listed first.

First, the related definitions of the parameters in the formulas and the inequalities in the embodiments of the present invention are provided, as shown in Table 1.

TABLE 1

| Parameter | Definition |
|---|---|
| M | Detection window parameter, where a maximum |
| | quantity of detection windows that is supported |
| | by single UE is 2M + 1 and the parameter is |
| | related to a frequency offset |
| m | Detection window of single |
| | UE, where mε{−M, . . . , 0, . . . , M} |
| u | Root sequence generation parameter |
| dᵤ | Offset of a peak shifted by a subcarrier |
| N_{CS} | Length of an uplink detection window |
| N_{ZC} | Length of an uplink access root sequence |
| mod | Modulo operation |
| xᵤ (n) | Root sequence |
| p | Minimum non-negative integer satisfying |
| | (p × u) mod N_{ZC} = 1 |
| d_{start ,n} | Start location of the n^{th} cyclic shift sequence |
| d_{start ,n1} | Start location of a detection window |
| | of the n^{th} cyclic shift sequence |
| d_{start ,n2} | End location of a detection window |
| | of the n^{th} cyclic shift sequence |

Second, the inequalities, such as an inequality (1) to an inequality (6), in the embodiments of the present invention are provided:

(m×dᵤ+N_{CS}−1)modN_{ZC}<(m×dᵤ)modN_{ZC} inequality (1);

(mₐ×dᵤ)modN_{ZC}≦(m_{b}×dᵤ)modN_{ZC} inequality (2);

(mₐ×dᵤ+N_{CS}−1)modN_{ZC}≧(m_{b}×dᵤ)modN_{ZC} inequality (3);

(m_{b}×dᵤ+N_{CS}−1)modN_{ZC}≧(mₐ×dᵤ)modN_{ZC} inequality (4); inequality (4);

(m_{b}×dᵤ+N_{CS}−1)modN_{ZC}≧(mₐ×dᵤ+N_{CS}−1)modN_{ZC} inequality (5); and

d_{start,}_{ₙ}≧N_{ZC}−N_{CS} inequality (6).

Third, the formulas, such as a formula (1) to a formula (6), in the embodiments of the present invention are provided:

$$\begin{matrix}{d}_{u} = \{ \begin{matrix}p & 0 \leq p \leq {N}_{ZC} / 2 \\ {N}_{ZC} - p & others\end{matrix} ; & formula ( 1 ) \\ {d}_{start {,}_{n 1}} = ( {d}_{start {,}_{n}} + m \times {d}_{u} ) mod {N}_{ZC} ; & formula ( 2 ) \\ {d}_{start {,}_{n 2}} = ( {d}_{start {,}_{n}} + m \times {d}_{u} + {N}_{CS} - 1 ) mod {N}_{ZC} ; & formula ( 3 ) \\ {d}_{start {,}_{n + 1}} = {d}_{start {,}_{n}} + {N}_{CS} ; & formula ( 4 ) \\ {d}_{start {,}_{n }} = {d}_{start {,}_{n}} + 1 ; and & formula ( 5 ) \\ {x}_{u} ( n ) = {e}^{\frac{- jun ( n + 1 )}{{N}_{ZC}}} . & formula ( 6 )\end{matrix}$$

The following describes the technical solutions in the embodiments of the present invention with reference to the accompanying drawings in the embodiments of the present invention. Apparently, the described embodiments are merely a part rather than all of the embodiments of the present invention. In the following descriptions, for the purpose of explanation but not for limitation, particular details are described for clear understanding. In some embodiments, elaboration of an apparatus, a circuit, and a method that are publicly known is omitted, so as to avoid ambiguous descriptions resulting from unnecessary details. In the specification, a same reference numeral or a same name refers to same or similar elements.

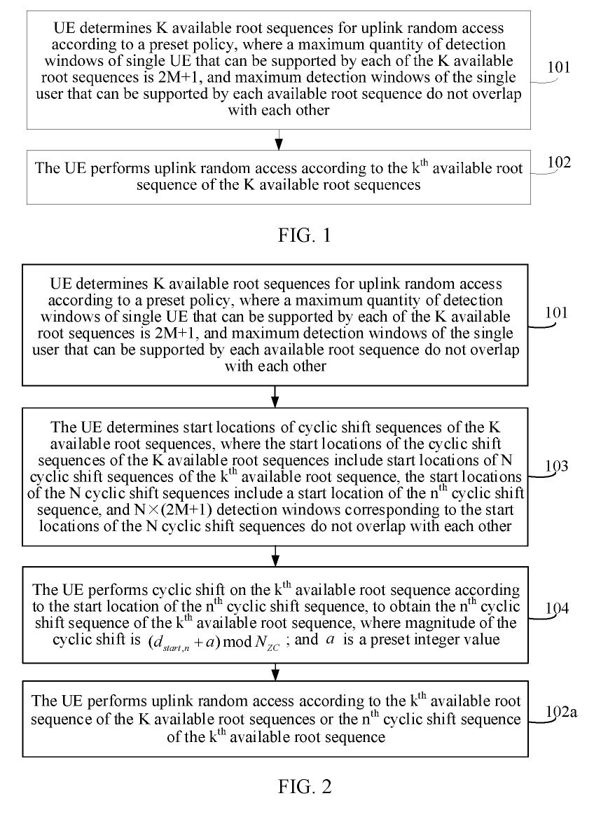

An embodiment of the present invention provides an uplink random access method. As shown in FIG. 1, the method includes the following steps.

S101: UE determines K available root sequences for uplink random access according to a preset policy, where a maximum quantity of detection windows of single UE that can be supported by each of the K available root sequences is 2M+1, and maximum detection windows of the single UE that can be supported by each available root sequence do not overlap with each other.

K≧1, M>1, and both K and M are integers.

Specifically, a detection window in this embodiment of the present invention is caused by a frequency offset. In a case of different frequency offsets, correlation peaks may be generated at multiple locations when a local sequence is correlated to a received sequence. The locations at which the correlation peaks may occur are locations of detection windows.

Specifically, in this embodiment of the present invention, the UE determines at least one available root sequence for uplink random access according to the preset policy, that is, the UE may determine multiple available root sequences for uplink random access according to the preset policy. For example, if there are sequence numbers 0 to 99 of 100 root sequences, the UE may sequentially determine, according to the preset policy, whether root sequences corresponding to the sequence numbers of the 100 root sequences are available root sequences; if a root sequence is not an available root sequence, the root sequence is skipped. If 50 root sequences are skipped, a quantity K of finally determined available root sequences for uplink random access is equal to 50. The maximum quantity of detection windows of the single UE that can be supported by each of the K available root sequences is 2M+1, where M>1, and maximum detection windows of the single UE that can be supported by each available root sequence do not overlap with each other. That is, the maximum quantity of detection windows of the single UE that can be supported by each available root sequence is at least five, and the detection windows of the single UE do not overlap with each other.

S102: The UE performs uplink random access according to the k^{th} available root sequence of the K available root sequences.

1≦k≦K and k is an integer.

That is, after determining the K available root sequences for uplink random access, the UE may perform uplink random access by using any one of the K available root sequences.

Based on the uplink random access method provided in this embodiment of the present invention, in this embodiment of the present invention, a maximum quantity of detection windows of single UE that can be supported by each available root sequence for uplink random access and that is determined by UE according to a preset policy is 2M+1, where M>1. That is, the maximum quantity of detection windows of the single UE that can be supported by each available root sequence for uplink random access and that is determined by the UE is at least five, and maximum detection windows that can be supported by each available root sequence do not overlap with each other, thereby avoiding a problem in the prior art that a success rate of uplink random access by UE is greatly decreased because a targeted design is generally applicable only to a relatively small frequency offset, for example, a maximum quantity of detection windows that can be supported by an available root sequence for uplink random access is three, and when the frequency offset is greater than a particular value, correlation peaks occur at multiple detection window locations after a local access sequence is correlated to a received access sequence, but a base station accesses the UE with a relatively large success rate when peaks occur at a maximum of three detection windows. In this embodiment of the present invention, the UE determines K available root sequences for uplink random access, where the maximum quantity of detection windows of the single UE that can be supported by each of the K available root sequences becomes larger. Therefore, when a frequency offset is greater than a particular value, and when correlation peaks occur at multiple locations after a local access sequence is correlated to a received access sequence, a base station can access the UE with a relatively large success rate when peaks occur at more detection windows, thereby improving a success rate of uplink random access when an uplink frequency offset is relatively large.

Preferably, in step S101 in this embodiment of the present invention, the preset policy may specifically include:

a root sequence satisfying none of the following condition A, condition B, and condition C is an available root sequence:

the condition A: any detection window m∈{−M, . . . , 0, . . . , M} of the single UE satisfies the inequality (1);

the condition B: any detection windows mₐ and m_{b} of the single UE, where mₐ≠m_{b} and mₐ,m_{b}∈{−M, . . . , 0, . . . , M}, satisfy the inequality (1) and the inequality (3); and

the condition C: any detection windows mₐ and m_{b} of the single UE, where mₐ≠m_{b} and mₐ,m_{b}∈{−M, . . . , 0, . . . , M}, satisfy the inequality (4) and the inequality (5).

It should be noted that the foregoing merely provides an example of a preset policy. The preset policy makes the maximum quantity of detection windows of the single UE that can be supported by the available root sequence for uplink random access and that is determined by the UE be at least five; certainly, there may be another preset policy that makes the maximum quantity of detection windows of the single UE that can be supported by the available root sequence for uplink random access and that is determined by the UE be at least five. This is not specifically limited in this embodiment of the present invention.

Further, as shown in FIG. 2, after the determining, by UE, K available root sequences for uplink random access according to a preset policy, the method further includes:

S103: The UE determines start locations of cyclic shift sequences of the K available root sequences, where the start locations of the cyclic shift sequences of the K available root sequences include start locations of N cyclic shift sequences of the k^{th} available root sequence, the start locations of the N cyclic shift sequences include a start location of the n^{th} cyclic shift sequence, and N×(2M+1) detection windows corresponding to the start locations of the N cyclic shift sequences do not overlap with each other.

1≦n≦N, N≧1, N indicates a quantity of cyclic shift sequences of the k^{th} available root sequence, and both n and N are integers.

Specifically, for each root sequence, more cyclic shift sequences may be generated, by means of cyclic shift, for uplink random access by the UE. Therefore, in this embodiment of the present invention, after determining the K available root sequences for uplink random access, the UE determines, for each available root sequence, start locations of multiple cyclic shift sequences of the root sequence. N×(2M+1) detection windows corresponding to the start locations of the multiple cyclic shift sequences of the root sequence do not overlap with each other. For example, for an available root sequence 1, if there are start locations of N=3 cyclic shift sequences for the available root sequence 1 and a start location of each cyclic shift sequence corresponds to five detection windows, the start locations of the three cyclic shift sequences correspond to 15 detection windows, and the 15 detection windows do not overlap with each other.

S104: The UE performs cyclic shift on the k^{th} available root sequence according to the start location of the n^{th} cyclic shift sequence, to obtain the n^{th} cyclic shift sequence of the k^{th} available root sequence, where magnitude of the cyclic shift is (d_{start,}_{ₙ}+a)modN_{ZC}; and a is a preset integer value.

Preferably, a may be prestored by the UE, or may be sent by a base station to the UE, that is, the base station configures same a for all UEs. This is not specifically limited in this embodiment of the present invention.

Further, the performing, by the UE, uplink random access according to the k^{th} available root sequence of the K available root sequences (step S102) may specifically include:

S102a: The UE performs uplink random access according to the k^{th} available root sequence of the K available root sequences or the n^{th} cyclic shift sequence of the k^{th} available root sequence.

That is, after determining the K available root sequences for uplink random access and the start locations of the cyclic shift sequences of the K available root sequences, the UE may perform uplink random access by using any one of the K available root sequences, or perform uplink random access according to the n^{th} cyclic shift sequence of the k^{th} available root sequence. This is not specifically limited in this embodiment of the present invention.

Specifically, in this embodiment of the present invention, because the UE determines, for each available root sequence, start locations of multiple cyclic shift sequences of the root sequence, the UE has more choices to perform uplink random access. Therefore, a probability of a conflict between UEs during uplink random access is decreased, thereby further improving a success rate of uplink random access when an uplink frequency offset is relatively large.

Preferably, the start location of the n^{th} cyclic shift sequence is obtained through calculation by using the following steps:

Step 1: Obtain a start location of a detection window of the n^{th} cyclic shift sequence according to the formula (2), and obtain an end location of the detection window of the n^{th} cyclic shift sequence according to the formula (3), where d_{start,}_{ₗ}=0 and d_{start,}_{ₙ}=d_{start,}_{_{n−1}}+N_{CS}.

Step 2: Determine, for any d_{start,}_{ₗ}∈v, whether a detection window corresponding to d_{start,}_{ₙ} and a detection window corresponding to d_{start,}_{ₗ} overlap, where v indicates a set of start locations of detection windows, and an initial set of v is v={d_{start,l}}.

Step 3: If the detection window corresponding to d_{start,}_{ₙ} and the detection window corresponding to d_{start,}_{ₗ} do not overlap, determine that the start location of the n^{th} cyclic shift sequence is d_{start,}_{ₙ} and add d_{start,}_{ₙ} to v.

Step 4: If the detection window corresponding to d_{start,}_{ₙ} and the detection window corresponding to d_{start,}_{ₗ} overlap, assume d_{start,}_{ₙ}=d_{start,}_{ₙ}+1 and repeatedly perform the foregoing step 1 to step 4 until d_{start,}_{ₙ}≧N_{ZC}−N_{CS}.

The following provides a method for determining the start locations of the N cyclic shift sequences of the k^{th} available root sequence with reference to a specific example.

For example, it is assumed that N_{ZC}=839, N_{CS}=18, u=78 , and M=2. Because m∈{−M, . . . , 0, . . . , M}, m∈{−2,−1,0,1,2}, that is, values of m may bₑ respectively −2, −1, 0, 1, and 2. If it is determined according to the preset policy that the root sequence xᵤ(n) is available, a method for determining start locations of N cyclic shift sequences of the available root sequence xᵤ(n) is as follows:

S1: When n=1, set an initial start location to d_{start,}_{ₗ}=0, so that a set of start locations of current detection windows is v={d_{start,l}}={0}.

S2: Assume that the values of m are respectively −2, −1, 0, 1, and 2, when n=1, obtain, through calculation according to the formula (2), start locations of 2*M+1=5 detection windows corresponding to d_{start,}_{ₙ}, which are respectively 0, 398, 796, 43, and 441, and when n=1, obtain, through calculation according to the formula (3), end locations of the 2*M+1=5 detection windows corresponding to d_{start,}_{ₙ} which are respectively 17, 415, 813, 60, and 458. Therefore, the 2*M+1=5 detection windows corresponding to d_{start,}_{ₙ} are [0, 17], [398, 415], [796, 813], [43, 60], and [441, 458].

S3: Assume n=n+1, that is, n=2, and obtain, through calculation according to the formula (4), a start location d_{start,}_{₂}=d_{start,}_{₁}+N_{CS}=0+18=18.

S4: Determine, according to the inequality (6), that a condition 18≧839−18 is false, and perform step S5.

S5: Similar to step S2, assume that the values of m are respectively −2, −1, 0, 1, and 2; and when n=2, respectively obtain, through calculation according to the formula (2) and the formula (3), five detection windows corresponding to d_{start,}_{ₙ}, which are [18, 35], [416, 433], [814, 831], [61, 78], and [459, 476].

S6: Compare the five detection windows with the detection windows [0, 17], [398, 415], [796, 813], [43, 60], and [441,458] that correspond to the existing set v={0} of start locations.

S7: If no overlap exists in a comparison result, add the start location d_{start,}_{₂}=18 to the set of start locations, that is, update the set of start locations to v={0,18}, so that a new set of detection windows that corresponds to the set v={0,18}of start locations is a union set of the detection windows corresponding to the start locations in the set of start locations, that is, [0, 17], [398, 415], [796, 813], [43, 60], [441, 458], [18, 35], [416, 433], [814, 831], [61, 78], and [459, 476].

S8: Similar to step S3 to step S6, assume n=n+1, that is, n=3, and obtain, through calculation according to the formula (4), d_{start,}_{₃}=d_{start,}_{₂}+N_{CS}=18+18=36; after it is determined that a condition 36÷839−18 is false, assume that the values of m are respectively −2, −1, 0, −1, and −2; when n=3, respectively obtain, through calculation according to the formula (2) and the formula (3), five detection windows corresponding to d_{start,}_{ₙ}, which are [36, 53], [434, 451], [832, 849], [79, 96], and [477, 494]; and then perform a step similar to S6, that is, compare the five detection windows with the detection windows [0, 17], [398, 415], [796, 813], [43, 60], [441, 458], [18, 35], [416, 433], [814, 831], [61, 78], and [459, 476] that correspond to the existing set v={0,18} of start locations.

S9: [36, 53] and [43, 60] that is in the existing detection windows overlap, and [434,451] and [441,458] that is in the existing detection windows overlap. That is, some detection windows overlap with each other. Therefore, the set v={0,18} of start locations cannot include a start location d_{start,}_{₃}=36 that is obtained through calculation when n=3, that is, the set v={0,18} of start locations cannot include 36. After d_{start,}_{₃}=d_{start,}_{₃}+1=37 is calculate according to the formula (5) when n=3, repeatedly perform steps similar to step S4 to step S6. If in a step similar to step S6, no overlap exists in a comparison result, perform a step similar to step S7; if in a step similar to step S6, an overlap exists in a comparison result, perform a step similar to step S8, and so on, until a condition of the inequality (6) is true, so that a set v={d_{start,1},dₛₜₐᵣₜ₂, . . . , d_{start,n}} of the start locations of the N cyclic shift sequences is obtained, and an entire calculation process ends.

Preferably, a configuration parameter in this embodiment of the present invention may be prestored by the UE, or may be sent by the base station to the UE. This is not specifically limited in this embodiment of the present invention. The configuration parameter includes at least one of the following parameters: M, N_{ZC}, or N_{CS}.

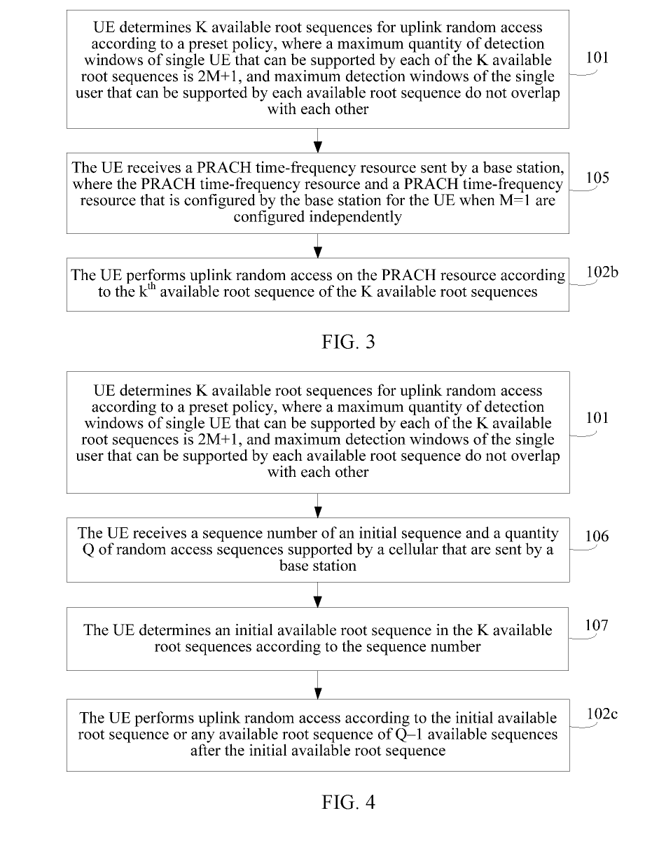

Further, as shown in FIG. 3, in this embodiment of the present invention, before the performing, by the UE, uplink random access according to the k^{th} available root sequence of the K available root sequences (step S102), the method may further include:

S105: The UE receives a PRACH time-frequency resource sent by a base station, where the PRACH time-frequency resource and a PRACH time-frequency resource that is configured by the base station for the UE when M=1 are configured independently.

Further, step S102 may specifically include:

S102b: The UE performs uplink random access on the PRACH resource according to the k^{th} available root sequence of the K available root sequences.

That is, in this embodiment of the present invention, in consideration of compatibility with a PRACH design standard of an existing LTE system, if a PRACH time-frequency resource that is configured by the base station for the UE when M>1 and a PRACH time-frequency resource that is configured by the base station for the UE when M=1 in an existing standard overlap, that different UEs contend for the PRACH time-frequency resource during uplink random access is easily caused. Consequently, a problem that a success rate of uplink random access by the UE is greatly decreased is caused. Therefore, in this embodiment of the present invention, the base station independently configures the PRACH time-frequency resource when M>1 and the PRACH time-frequency resource when M=1, thereby avoiding the problem that the success rate of uplink random access by the UE is greatly decreased because the PRACH time-frequency resource that is configured by the base station for the UE when M>1 and the PRACH time-frequency resource that is configured by the base station for the UE when M=1 in the existing standard overlap, and further improving a success rate of uplink random access when an uplink frequency offset is relatively large.

Further, as shown in FIG. 4, in this embodiment of the present invention, after the determining, by UE, K available root sequences for uplink random access according to a preset policy (step S101) and before the performing, by the UE, uplink random access according to the k^{th} available root sequence of the K available root sequences (step S102), the method further includes:

S106: The UE receives a sequence number of an initial sequence and a quantity Q of random access sequences supported by a cellular cell that are sent by the base station.

Q≧1 and Q is an integer.

Specifically, in this embodiment of the present invention, the sequence number of the initial sequence that is sent by the base station to the UE may be a sequence number of an available root sequence determined by the base station or may be a sequence number of a non-available root sequence. This is not specifically limited in this embodiment of the present invention.

S107: The UE determines an initial available root sequence in the K available root sequences according to the sequence number.

Specifically, in this embodiment of the present invention, after receiving the sequence number, the UE may determine, in the K available root sequences, that the first available root sequence after the sequence number is the initial available root sequence. For example, if root sequences whose sequence numbers are 10, 12, 13, and 15 are non-available root sequences and the sequence number of the initial sequence that is sent by the base station to the UE is 12, the UE may determine that the initial available root sequence is an available root sequence whose root sequence number is 14.

Further, step S102 may specifically include:

S102c: The UE performs uplink random access according to the initial available root sequence or any one of available root sequence of Q−1 available sequences after the initial available root sequence.

Specifically, in this embodiment of the present invention, the Q−1 available sequences after the initial available root sequence may specifically include root sequences, and may also include cyclic shift sequences of the root sequences that are obtained according to the foregoing method embodiments. This is not specifically limited in this embodiment of the present invention.

Based on the foregoing solution of this embodiment of the present invention, UE may select an uplink random access sequence according to a sequence number of an initial sequence and a quantity Q of random access sequences supported by a cellular cell that are sent by a base station, thereby avoiding a conflict that may be caused when UEs in different cells perform uplink random access, and further improving a success rate of uplink random access when an uplink frequency offset is relatively large.

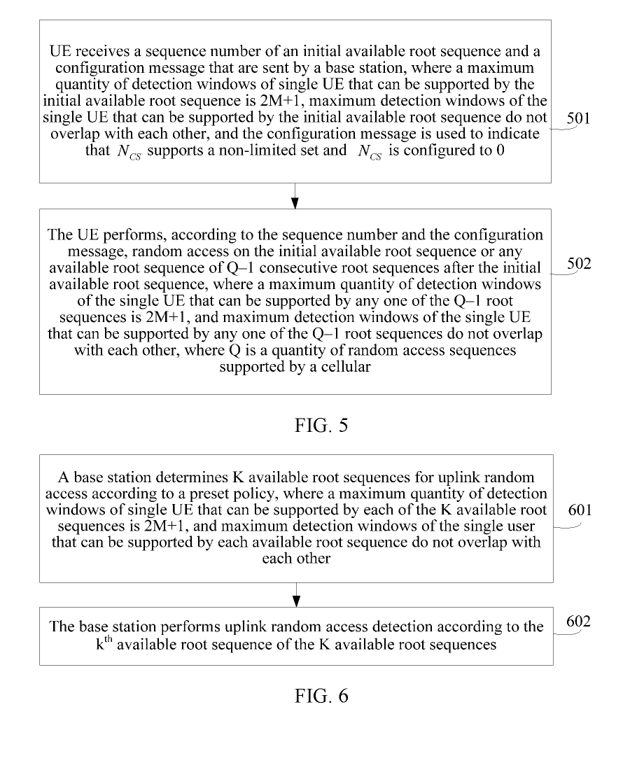

An embodiment of the present invention provides an uplink random access method. As shown in FIG. 5, the method includes the following steps.

S501: UE receives a sequence number of an initial available root sequence and a configuration message that are sent by a base station, where a maximum quantity of detection windows of single UE that can be supported by the initial available root sequence is 2M+1, maximum detection windows of the single UE that can be supported by the initial available root sequence do not overlap with each other, and the configuration message is used to indicate that N_{CS} supports a non-limited set and N_{CS} is configured to 0.

M>1, and M is an integer.

Specifically, in a standard of an existing LTE system, the base station indicates an available uplink access sequence to the UE by using the configuration message, and the base station notifies the UE of a size of an uplink detection window by sending the configuration message of N_{CS}. The UE obtains, through calculation, an available root sequence and an available cyclic shift sequence by using an obtained value of N_{CS}. The value of N_{CS} may be obtained by using a configuration of N_{CS} and a message indicating whether a non-limited set is supported. A correspondence between a configuration of N_{CS} and a value of N_{CS} is shown in Table 2. When N_{CS} is configured to 0 and supports a non-limited set, an obtained value of N_{CS} is 0; when N_{CS} is configured to 0 and does not support a non-limited set, an obtained value of N_{CS} is 15; when N_{CS} is configured to 1 and supports a non-limited set, an obtained value of N_{CS} is 13; or when N_{CS} is configured to 1 and does not support a non-limited set, an obtained value of N_{CS} is 18.

TABLE 2

| | Value of N_{CS} | |
|---|---|---|
| Configuration | Non-limited | Limited |
| of N_{CS} | set | set |
| 0 | 0 | 15 |
| 1 | 13 | 18 |
| 2 | 15 | 22 |
| 3 | 18 | 26 |
| 4 | 22 | 32 |
| 5 | 26 | 38 |
| 6 | 32 | 46 |
| 7 | 38 | 55 |
| 8 | 46 | 68 |
| 9 | 59 | 82 |
| 10 | 76 | 100 |
| 11 | 93 | 128 |
| 12 | 119 | 158 |
| 13 | 167 | 202 |
| 14 | 279 | 237 |
| 15 | 419 | — |

In this embodiment of the present invention, the configuration message is used to indicate that N_{CS} supports a non-limited set and N_{CS} is configured to 0. Therefore, the value of N_{CS} obtained by the UE is 0.

S502: The UE performs, according to the sequence number and the configuration message, random access on the initial available root sequence or any one of Q−1 consecutive available root sequences after the initial available root sequence, where a maximum quantity of detection windows of the single UE that can be supported by any one of the Q−1 root sequences is 2M+1, and maximum detection windows of the single UE that can be supported by any one of the Q−1 root sequences do not overlap with each other, where Q is a quantity of random access sequences supported by a cellular cell.

Q≧1 and Q is an integer.

Based on the uplink random access method provided in this embodiment of the present invention, on one hand, a maximum quantity of detection windows of single UE that can be supported by an initial available root sequence or any one of Q−1 consecutive available root sequences after the initial available root sequence is 2M+1, where M>1. That is, the maximum quantity of detection windows of the single UE that can be supported by each available root sequence is at least five, and maximum detection windows that can be supported by each available root sequence do not overlap with each other, thereby avoiding a problem in the prior art that a success rate of uplink random access by UE is greatly decreased because a targeted design is generally applicable only to a relatively small frequency offset, for example, a maximum quantity of detection windows that can be supported by an available root sequence for uplink random access is three, and when the frequency offset is greater than a particular value, correlation peaks occur at multiple detection window locations after a local access sequence is correlated to a received access sequence, but a base station accesses the UE with a relatively large success rate when peaks occur at a maximum of three detection windows. In this embodiment of the present invention, a base station sends an initial available root sequence or Q−1 consecutive available root sequences after the initial available root sequence, where the maximum quantity of detection windows of the single UE that can be supported by each available root sequence becomes larger. Therefore, when a frequency offset is greater than a particular value, and when correlation peaks occur at multiple locations after a local access sequence is correlated to a received access sequence, the base station can access the UE with a relatively large success rate when peaks occur at more detection windows, thereby improving a success rate of uplink random access when an uplink frequency offset is relatively large. On the other hand, a configuration message sent by the base station indicates that N_{CS} supports a non-limited set and N_{CS}=0, that is, it is represented that available root sequences determined when M=1 and these available root sequences overlap. Therefore, low-version UE is allowed to perform uplink random access by using these available root sequences, thereby better achieving backward compatibility.

An embodiment of the present invention provides an uplink random access method. As shown in FIG. 6, the method includes the following steps.

S601: A base station determines K available root sequences for uplink random access according to a preset policy, where a maximum quantity of detection windows of single UE that can be supported by each of the K available root sequences is 2M+1, and maximum detection windows of the single UE that can be supported by each available root sequence do not overlap with each other.

K≧1, M>1, and both K and M are integers.

Specifically, a detection window in this embodiment of the present invention is caused by a frequency offset. In a case of different frequency offsets, correlation peaks may be generated at multiple locations when a local sequence is correlated to a received sequence. The locations at which the correlation peaks may occur are locations of detection windows.

Specifically, in this embodiment of the present invention, the base station determines at least one available root sequence for uplink random access according to the preset policy, that is, the base station may determine multiple available root sequences for uplink random access according to the preset policy. For example, if there are sequence numbers 0 to 99 of 100 root sequences, the base station may sequentially determine, according to the preset policy, whether root sequences corresponding to the sequence numbers of the 100 root sequences are available root sequences; if a root sequence is not an available root sequence, the root sequence is skipped. If 60 root sequences are skipped, a quantity K of finally determined available root sequences for uplink random access is equal to 40. The maximum quantity of detection windows of the single UE that can be supported by each of the K available root sequences is 2M+1, where M>1, and maximum detection windows of the single UE that can be supported by each available root sequence do not overlap with each other. That is, the maximum quantity of detection windows of the single UE that can be supported by each available root sequence is at least five, and the detection windows of the single UE do not overlap with each other.

S602: The base station performs uplink random access detection according to the k^{th} available root sequence of the K available root sequences.

1≦k≦K and k is an integer.

That is, after determining the K available root sequences for uplink random access, the base station may perform uplink random access detection by using any one of the K available root sequences.

Based on the uplink random access method provided in this embodiment of the present invention, in this embodiment of the present invention, a maximum quantity of detection windows of single UE that can be supported by each available root sequence for uplink random access and that is determined by a base station according to a preset policy is 2M+1, where M>1. That is, the maximum quantity of detection windows of the single UE that can be supported by each available root sequence for uplink random access and that is determined by the base station is at least five, and maximum detection windows that can be supported by each available root sequence do not overlap with each other, thereby avoiding a problem in the prior art that a success rate of uplink random access by UE is greatly decreased because a targeted design is generally applicable only to a relatively small frequency offset, for example, a maximum quantity of detection windows that can be supported by an available root sequence for uplink random access is three, and when the frequency offset is greater than a particular value, correlation peaks occur at multiple detection window locations after a local access sequence is correlated to a received access sequence, but a base station accesses the UE with a relatively large success rate when peaks occur at a maximum of three detection windows. In the embodiments of the present invention, the base station determines K available root sequences for uplink random access, where the maximum quantity of detection windows of the single UE that can be supported by each of the K available root sequences becomes larger. Therefore, when a frequency offset is greater than a particular value, and when correlation peaks occur at multiple locations after a local access sequence is correlated to a received access sequence, a base station can access the UE with a relatively large success rate when peaks occur at more detection windows, thereby improving a success rate of uplink random access when an uplink frequency offset is relatively large.

Preferably, in step S601 in this embodiment of the present invention, the preset policy may specifically include:

a root sequence satisfying none of the following condition A, condition B, and condition C is an available root sequence:

the condition A: any detection window m∈{−M, . . . , 0, . . . , M} of the single UE satisfies the inequality (1);

the condition B: any detection windows mₐ and m_{b} of the single UE, where mₐ≠m_{b} and mₐ,m_{b}∈{−M, . . . , 0, . . . , M}, satisfy the inequality (1) and the inequality (3); and

the condition C: any detection windows mₐ and m_{b} of the single UE, where mₐ≠m_{b} and mₐ,m_{b}∈{−M, . . . , 0, . . . , M}, satisfy the inequality (4) and the inequality (6).

It should be noted that the foregoing merely provides an example of a preset policy. The preset policy makes the maximum quantity of detection windows of the single UE that can be supported by the available root sequence for uplink random access and that is determined by the base station be at least five; certainly, there may be another preset policy that makes the maximum quantity of detection windows of the single UE that can be supported by the available root sequence for uplink random access and that is determined by the base station be at least five. This is not specifically limited in this embodiment of the present invention.

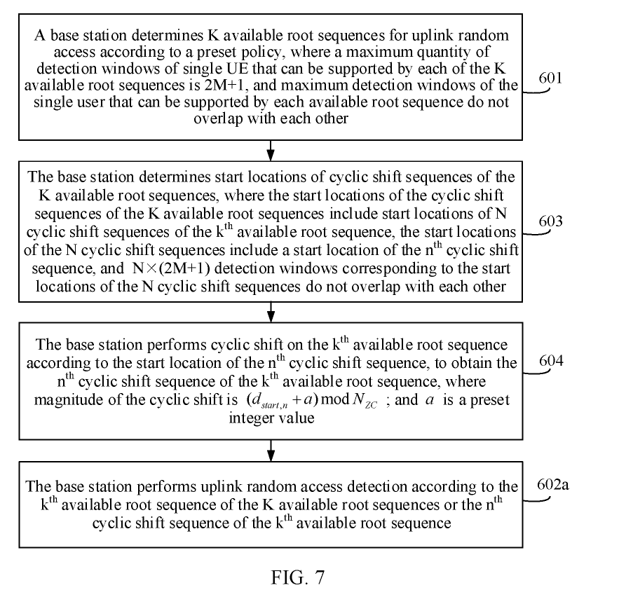

Further, as shown in FIG. 7, after the determining, by a base station, K available root sequences for uplink random access according to a preset policy, the method further includes:

S603: The base station determines start locations of cyclic shift sequences of the K available root sequences, where the start locations of the cyclic shift sequences of the K available root sequences include start locations of N cyclic shift sequences of the k^{th} available root sequence, the start locations of the N cyclic shift sequences include a start location of the n^{th} cyclic shift sequence, and N×(2M+1) detection windows corresponding to the start locations of the N cyclic shift sequences do not overlap with each other.

1≦n≦N, N≧1, N indicates a quantity of cyclic shift sequences of the k^{th} available root sequence, and both n and N are integers.

Specifically, for each root sequence, more cyclic shift sequences may be generated, by means of cyclic shift, for uplink random access by UE. Therefore, in this embodiment of the present invention, after determining the K available root sequences for uplink random access, the base station determines, for each available root sequence, start locations of multiple cyclic shift sequences of the root sequence. N×(2M+1) detection windows corresponding to the start locations of the multiple cyclic shift sequences of the root sequence do not overlap with each other. For example, for an available root sequence 1, if there are start locations of N=3 cyclic shift sequences of the available root sequence and a start location of each cyclic shift sequence corresponds to six detection windows, the start locations of the three cyclic shift sequences correspond to 16 detection windows, and the 16 detection windows do not overlap with each other.

S604: The base station performs cyclic shift on the k^{th} available root sequence according to the start location of the n^{th} cyclic shift sequence, to obtain the n^{th} cyclic shift sequence of the k^{th} available root sequence, where magnitude of the cyclic shift is (d_{start,}_{ₙ}+a)modN_{ZC}; and a is a preset integer value.

Specifically, a is generally a same parameter configured by the base station for all UEs, so that each UE may shift an original random access sequence by a.

Further, the performing, by the base station, uplink random access detection according to the k^{th} available root sequence of the K available root sequences (step S602) may specifically include:

S602a: The base station performs uplink random access detection according to the k^{th} available root sequence of the K available root sequences or the n^{th} cyclic shift sequence of the k^{th} available root sequence.

That is, after determining the K available root sequences for uplink random access and the start locations of the cyclic shift sequences of the K available root sequences, the base station may perform uplink random access detection by using any one of the K available root sequences, or perform uplink random access detection according to the n^{th} cyclic shift sequence of the k^{th} available root sequence. This is not specifically limited in this embodiment of the present invention.

Specifically, in this embodiment of the present invention, because the base station determines, for each available root sequence, start locations of multiple cyclic shift sequences of the available root sequence, that is, the UE has more choices to perform uplink random access. Therefore, a probability of a conflict between UEs during uplink random access is decreased, thereby further improving a success rate of uplink random access when an uplink frequency offset is relatively large.

Preferably, the start location of the n^{th} cyclic shift sequence is obtained through calculation by using the following steps:

Step 1: Obtain a start location of a detection window of the n^{th} cyclic shift sequence according to the formula (2), and obtain an end location of the detection window of the n^{th} cyclic shift sequence according to the formula (3), where d_{start,}_{ₗ}=0 and d_{start,}_{ₙ}=d_{start,}_{_{n−1}}+N_{CS}.

Step 2: Determine, for any d_{start,}_{ₗ}∈v, whether a detection window corresponding to d_{start,}_{ₙ} and a detection window corresponding to d_{start,}_{ₗ} overlap, where v indicates a set of start locations of detection windows, and an initial set of v is v={d_{start,l}}.

Step 3: If the detection window corresponding to d_{start,}_{ₙ} and the detection window corresponding to d_{start,}_{ₗ} do not overlap, determine that the start location of the n^{th} cyclic shift sequence is d_{start,}_{ₙ} and add d_{start,}_{ₙ} to v.

Step 4: If the detection window corresponding to d_{start,}_{ₙ} and the detection window corresponding to d_{start,}_{ₗ} overlap, assume d_{start,}_{ₙ}=d_{start,}_{ₙ}+1 and repeatedly perform the foregoing step 1 to step 4 until d_{start,}_{ₙ}≧N_{ZC}−N_{CS}.

Specifically, for a method for determining the start locations of the N cyclic shift sequences of the k^{th} available root sequence, refer to descriptions of the foregoing method embodiments, and details are not described in this embodiment of the present invention again.

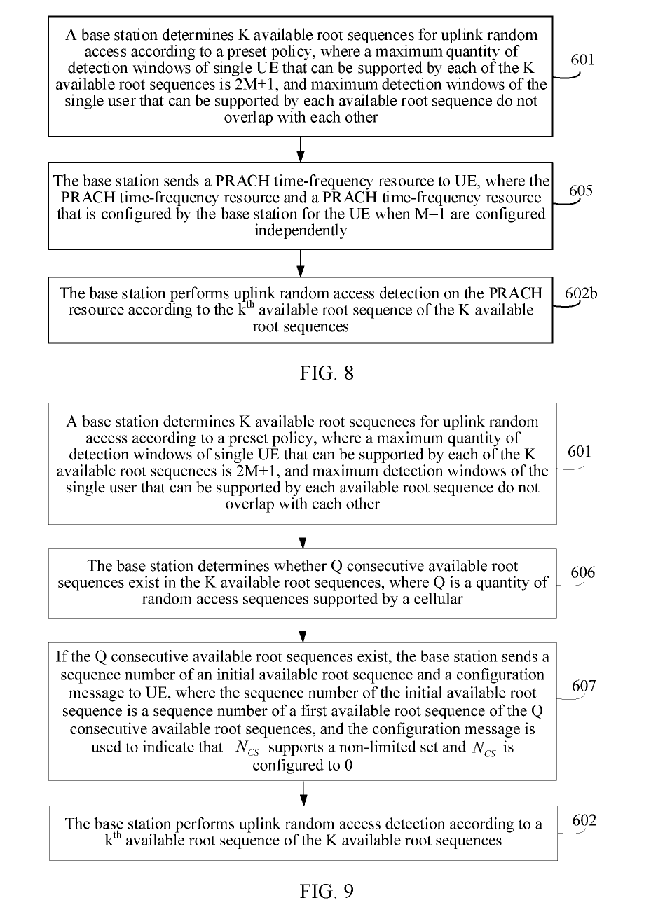

Further, as shown in FIG. 8, in this embodiment of the present invention, before the performing, by the base station, uplink random access detection according to the k^{th} available root sequence of the K available root sequences (step S602), the method may further include:

S605: The base station sends a PRACH time-frequency resource to UE, where the PRACH time-frequency resource and a PRACH time-frequency resource that is configured by the base station for the UE when M=1 are configured independently.

Further, step S602 may specifically include:

S602b: The base station performs uplink random access detection on the PRACH resource according to the k^{th} available root sequence of the K available root sequences.

That is, in this embodiment of the present invention, in consideration of compatibility with a PRACH design standard of an existing LTE system, if a PRACH time-frequency resource that is configured by the base station for the UE when M>1 and a PRACH time-frequency resource that is configured by the base station for the UE when M=1 in an existing standard overlap, that different UEs contend for the PRACH time-frequency resource during uplink random access is easily caused. Consequently, a problem that a success rate of uplink random access by the UE is greatly decreased is caused. Therefore, in this embodiment of the present invention, the base station independently configures the PRACH time-frequency resource when M>1 and the PRACH time-frequency resource when M=1, thereby avoiding the problem that the success rate of uplink random access by the UE is greatly decreased because the PRACH time-frequency resource that is configured by the base station for the UE when M>1 and the PRACH time-frequency resource that is configured by the base station for the UE when M=1 in the existing standard overlap, and further improving a success rate of uplink random access when an uplink frequency offset is relatively large.

Further, as shown in FIG. 9, in this embodiment of the present invention, after the determining, by a base station, K available root sequences for uplink random access according to a preset policy (step S601) and before the performing, by the base station, uplink random access detection according to the k^{th} available root sequence of the K available root sequences (step S602), the method may further include:

S606: The base station determines whether Q consecutive available root sequences exist in the K available root sequences, where Q is a quantity of random access sequences supported by a cellular cell.

1≦Q≦K and Q is an integer.

S607: If the Q consecutive available root sequences exist, the base station sends a sequence number of an initial available root sequence and a configuration message to the UE, where the sequence number of the initial available root sequence is a sequence number of the first available root sequence of the Q consecutive available root sequences, and the configuration message is used to indicate that N_{CS} supports a non-limited set and N_{CS} is configured to 0.

That is, in this embodiment of the present invention, the configuration message sent by the base station indicates that N_{CS} supports a non-limited set and N_{CS} is configured to 0, that is, it is represented that available root sequences determined when M=1 and these available root sequences overlap. Therefore, low-version UE is allowed to perform uplink random access by using these available root sequences, thereby better achieving backward compatibility.

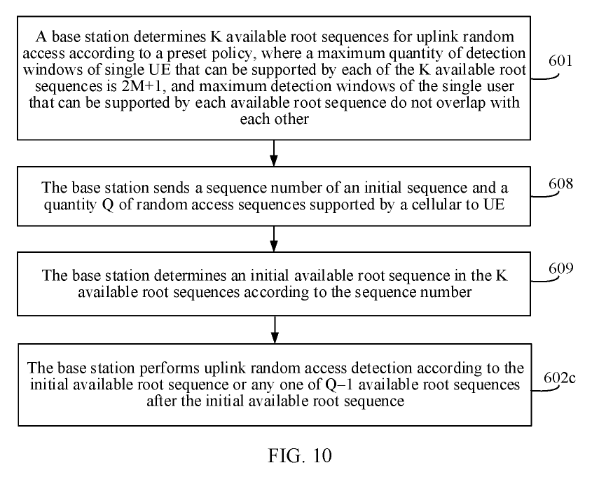

Further, as shown in FIG. 10, after the determining, by a base station, K available root sequences for uplink random access according to a preset policy (step S601) and before the performing, by the base station, uplink random access detection according to the k^{th} available root sequence of the K available root sequences (step S602), the method may further include:

S608: The base station sends a sequence number of an initial sequence and a quantity Q of random access sequences supported by a cellular cell to the UE.

Q≧1 and Q is an integer.

Specifically, in this embodiment of the present invention, the sequence number of the initial sequence that is sent by the base station to the UE may be a sequence number of an available root sequence determined by the base station or may be a sequence number of a non-available root sequence. This is not specifically limited in this embodiment of the present invention.

S609: The base station determines an initial available root sequence in the K available root sequences according to the sequence number.

Specifically, in this embodiment of the present invention, after determining the sequence number sent to the UE, the base station may determine, in the K available root sequences, that the first available root sequence after the sequence number is the initial available root sequence. For example, if root sequences whose sequence numbers are 10, 12, 13, and 15 are non-available root sequences and the sequence number of the initial sequence that is sent by the base station to the UE is 12, the base station may determine that the initial available root sequence is an available root sequence whose root sequence number is 14.

Further, step S602 may specifically include:

S602c: The base station performs uplink random access detection according to the initial available root sequence or any one of Q−1 available root sequences after the initial available root sequence.

Specifically, in this embodiment of the present invention, the Q−1 available sequences after the initial available root sequence may specifically include root sequences, and may also include cyclic shift sequences of the root sequences that are obtained according to the foregoing method embodiments. This is not specifically limited in this embodiment of the present invention.

Based on the foregoing solution provided in this embodiment of the present invention, a base station may perform uplink random access sequence detection according to a sequence number of an initial sequence and a quantity Q of random access sequences supported by a cellular cell, thereby avoiding a problem that uplink random access by UE in a cell fails because the base station detects uplink random access sequences of UEs in other different cells during uplink random access sequence detection, and further improving a success rate of uplink random access when an uplink frequency offset is relatively large.

An embodiment of the present invention provides UE 110. As shown in FIG. 11, the UE 110 includes: a determining unit 1101 and an access unit 1102.

The determining unit 1101 is configured to determine K available root sequences for uplink random access according to a preset policy, where a maximum quantity of detection windows of single UE 110 that can be supported by each of the K available root sequences is 2M+1, and maximum detection windows of the single UE 110 that can be supported by each available root sequence do not overlap with each other, where K≧1, M>1, and both K and M are integers.

The access unit 1102 is configured to perform uplink random access according to the k^{th} available root sequence of the K available root sequences, where 1≦k≦K and k is an integer.

In a possible implementation, the preset policy includes:

a root sequence satisfying none of the following condition A, condition B, and condition C is an available root sequence:

the condition A: any detection window m∈{−M, . . . , 0, . . . , M} of the single UE 110 satisfies the inequality (1);

the condition B: any detection windows mₐ and m_{b} of the single UE 110, where mₐ≠m_{b} and mₐ,m_{b}∈{−M, . . . , 0, . . . M},satisfy the inequality (2) and the inequality (3); and

the condition C: any detection windows mₐ and m_{b} of the single UE 110, where mₐ≠m_{b} and mₐ, m_{b}∈{−M, . . . , 0, . . . , M}, satisfy the inequality (4) and the inequality (5).

Further, as shown in FIG. 12, the UE 110 further includes a generation unit 1103.

The determining unit 1101 is further configured to: after determining the K available root sequences for uplink random access according to the preset policy, determine start locations of cyclic shift sequences of the K available root sequences, where the start locations of the cyclic shift sequences of the K available root sequences include start locations of N cyclic shift sequences of the k^{th} available root sequence, the start locations of the N cyclic shift sequences include a start location of the n^{th} cyclic shift sequence, and N×(2M+1) detection windows corresponding to the start locations of the N cyclic shift sequences do not overlap with each other, where 1≦n≦N, N≧1, N indicates a quantity of cyclic shift sequences of the k^{th} available root sequence, and both n and N are integers.

The generation unit 1103 is configured to perform cyclic shift on the k^{th} available root sequence according to the start location of the n^{th} cyclic shift sequence, to obtain the n^{th} cyclic shift sequence of the k^{th} available root sequence, where magnitude of the cyclic shift is (d_{start,}_{ₙ}+a)modN_{ZC}; and a is a preset integer value.

The access unit 1102 is specifically configured to:

perform uplink random access according to the k^{th} available root sequence of the K available root sequences or the n^{th} cyclic shift sequence of the k^{th} available root sequence.

Preferably, a is prestored by the UE 110 or is sent by a base station to the UE 110.

In a possible implementation, the determining unit 1101 is specifically configured to:

obtain a start location of a detection window of the n^{th} cyclic shift sequence according to the formula (2);

obtain an end location of the detection window of the n^{th} cyclic shift sequence according to the formula (3),

where d_{start,}_{ₗ}=0 and d_{start,}_{ₙ}=d_{start,}_{_{n−1}}+N_{CS};

determine, for any d_{start,}_{ₗ}∈v, whether a detection window corresponding to d_{start,}_{ₙ} and a detection window corresponding to d_{start,}_{ₗ} overlap, where v indicates a set of start locations of detection windows, and an initial set of v is v={d_{start,l}};

if the detection window corresponding to d_{start,}_{ₙ} and the detection window corresponding to d_{start,}_{ₗ} do not overlap, determine that the start location of the n^{th} cyclic shift sequence is d_{start,}_{ₙ} and add d_{start,}_{ₙ} to v; and

if the detection window corresponding to d_{start,}_{ₙ} and the detection window corresponding to d_{start,}_{ₗ} overlap, assume d_{start,}_{ₙ}=d_{start,}_{ₙ}+1 and repeatedly perform the foregoing steps until d_{start,}_{ₙ}≧N_{ZC}−N_{CS}.

Preferably, a configuration parameter is prestored by the UE 110 or is sent by the base station to the UE 110, where the configuration parameter include at least one of the following parameters: M, N_{ZC}, or N_{CS}.

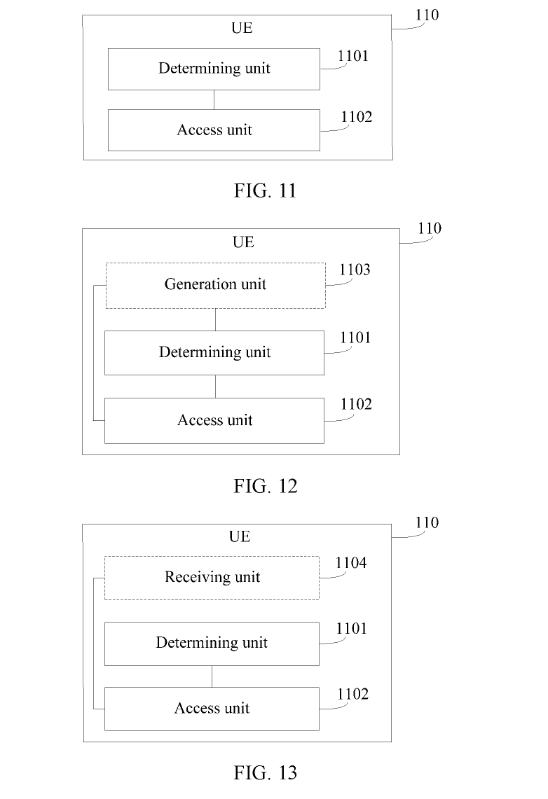

Further, as shown in FIG. 13, the UE 110 further includes a receiving unit 1104.

The receiving unit 1104 is configured to: before the access unit 1102 performs uplink random access according to the k^{th} available root sequence of the K available root sequences, receive a physical random access channel PRACH time-frequency resource sent by the base station, where the PRACH time-frequency resource and a PRACH time-frequency resource that is configured by the base station for the UE 110 when M=1 are configured independently.

The access unit 1102 is specifically configured to: perform uplink random access on the PRACH according to the k^{th} available root sequence of the K available root sequences.

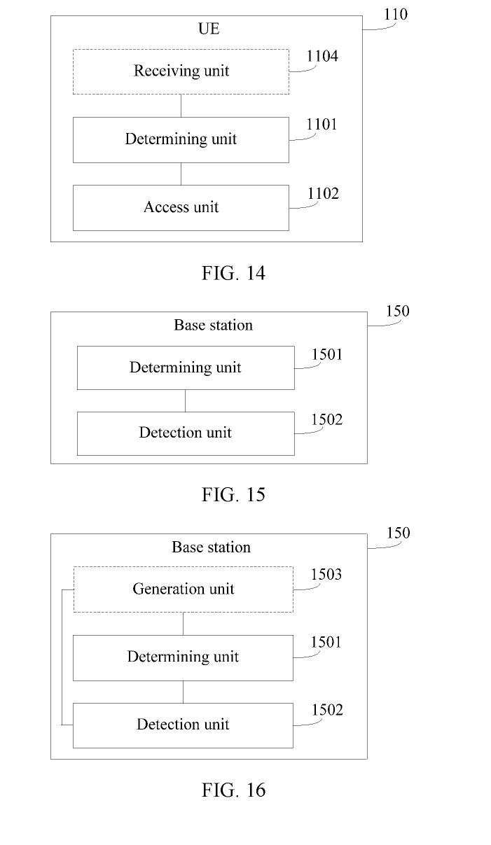

Further, as shown in FIG. 14, the UE 110 further includes a receiving unit 1104.

The receiving unit 1104 is configured to: after the determining unit 1101 determines the K available root sequences for uplink random access according to the preset policy and before the access unit 1102 performs uplink random access according to the k^{th} available root sequence of the K available root sequences, receive a sequence number of an initial sequence and a quantity Q of random access sequences supported by a cellular cell that are sent by the base station, where Q≧1 and Q is an integer.

The determining unit 1101 is further configured to determine an initial available root sequence in the K available root sequences according to the sequence number.

The access unit 1102 is specifically configured to:

perform uplink random access according to the initial available root sequence or any one of available root sequence of Q−1 available sequences after the initial available root sequence.

Specifically, for a method for performing uplink random access by the UE 110 shown in FIG. 11 to FIG. 14, refer to the foregoing method embodiments, and details are not described in this embodiment of the present invention again.

It should be noted that in FIG. 12 to FIG. 14, units indicated by dashed lines are newly added units based on FIG. 11, and these units are optional units. This is not specifically limited in this embodiment of the present invention.

In the embodiments of the UE 110 shown in FIG. 11 to FIG. 14, the receiving unit 1104 may be implemented by a receiver; the determining unit 1101, the access unit 1102, and the generation unit 1103 may be implemented by a processor. Functions of the foregoing units or steps performed by the foregoing units may be correspondingly completed by the processor. The receiver and the processor may communicate with each other. This is not specifically limited in this embodiment of the present invention.

Because the UE 110 shown in FIG. 11 to FIG. 14 can be configured to perform the foregoing methods, for technical effects that can be achieved by the UE 110, refer to descriptions of the foregoing method embodiments, and details are not described herein again.

An embodiment of the present invention further provides a base station 150. As shown in FIG. 15, the base station 150 includes: a determining unit 1501 and a detection unit 1502.

The determining unit 1501 is configured to determine K available root sequences for uplink random access according to a preset policy, where a maximum quantity of detection windows of single UE that can be supported by each of the K available root sequences is 2M+1, and maximum detection windows of the single UE that can be supported by each available root sequence do not overlap with each other, where K≧1, M>1, and both K and M are integers.

The detection unit 1502 is configured to perform uplink random access detection according to the k^{th} available root sequence of the K available root sequences, where 1≦k≦K and k is an integer.

In a possible implementation, the preset policy includes:

a root sequence satisfying none of the following condition A, condition B, and condition C is an available root sequence:

the condition A: any detection window m∈{−M, . . . , 0, . . . , M} of the single UE satisfies the inequality (1);

the condition B: any detection windows mₐ and m_{b} of the single UE, where mₐ≠m_{b} and mₐ,m_{b}∈{−M, . . . , 0, . . . , M}, satisfy the inequality (2) and the inequality (3); and

the condition C: any detection windows mₐ and m_{b} of the single UE, where mₐ≠m_{b} and mₐ,m_{b}∈{−M, . . . , 0, . . . , M}, satisfy the inequality (4) and the inequality (5).

Further, as shown in FIG. 16, the base station 150 further includes a generation unit 1503.

The determining unit 1501 is further configured to: after determining the K available root sequences for uplink random access according to the preset policy, determine start locations of cyclic shift sequences of the K available root sequences, where the start locations of the cyclic shift sequences of the K available root sequences include start locations of N cyclic shift sequences of the k^{th} available root sequence, the start locations of the N cyclic shift sequences include a start location of the n^{th} cyclic shift sequence, and N×(2M+1) detection windows corresponding to the start locations of the N cyclic shift sequences do not overlap with each other, where 1≦n≦N, N≧1, N indicates a quantity of cyclic shift sequences of the k^{th} available root sequence, and both n and N are integers.

The generation unit 1503 is configured to perform cyclic shift on the k^{th} available root sequence according to the start location of the n^{th} cyclic shift sequence, to obtain the n^{th} cyclic shift sequence of the k^{th} available root sequence, where magnitude of the cyclic shift is (d_{start,}_{ₙ}+a)modN_{ZC}; and a is a preset integer value.

The detection unit 1502 is specifically configured to:

perform uplink random access detection according to the k^{th} available root sequence of the K available root sequences or the n^{th} cyclic shift sequence of the k^{th} available root sequence.

Further, the determining unit 1501 is specifically configured to:

obtain a start location of a detection window of the n^{th} cyclic shift sequence according to the formula (2);

obtain an end location of the detection window of the n^{th} cyclic shift sequence according to the formula (3),

where d_{start,}_{ₗ}=0 and d_{start,}_{ₙ}=d_{start,}_{_{n−1}}+N_{CS};

determine, for any d_{start,}_{ₗ}∈v, whether a detection window corresponding to d_{start,}_{ₙ} and a detection window corresponding to d_{start,}_{ₗ} overlap, where v indicates a set of start locations of detection windows, and an initial set of v is v={_{start,l}};

if the detection window corresponding to d_{start,}_{ₙ} and the detection window corresponding to d_{start,}_{ₗ} do not overlap, determine that the start location of the n^{th} cyclic shift sequence is d_{start,}_{ₙ} and add d_{start,}_{ₙ} to v; and

if the detection window corresponding to d_{start,}_{ₙ} and the detection window corresponding to d_{start,}_{ₗ} overlap, assume d_{start,}_{ₙ}=d_{start,}_{ₙ}+1 and repeatedly perform the foregoing steps until d_{start,}_{ₙ}≧N_{ZC}−N_{CS}.

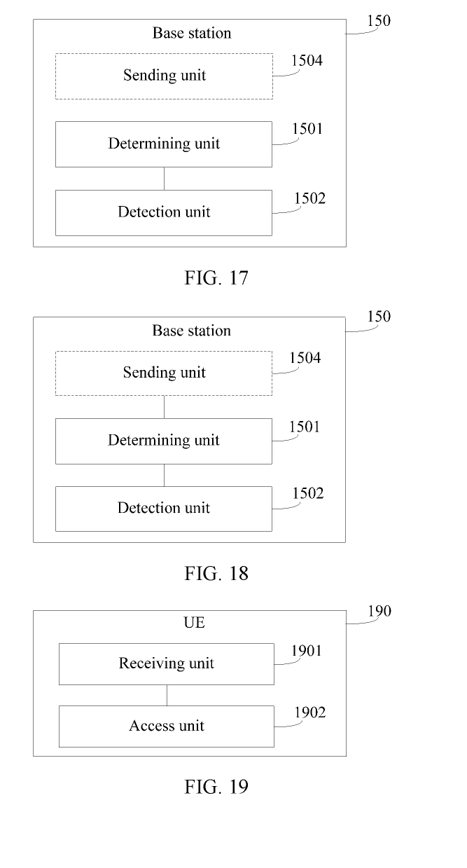

Further, as shown in FIG. 17, the base station 150 further includes a sending unit 1504.

The sending unit 1504 is configured to: before the detection unit 1502 performs uplink random access detection according to the k^{th} available root sequence of the K available root sequences, send a physical random access channel PRACH time-frequency resource to user equipment UE, where the PRACH time-frequency resource and a PRACH time-frequency resource that is configured by the base station 150 for the UE when M=1 are configured independently.

The detection unit 1502 is specifically configured to:

perform uplink random access detection on the PRACH according to the k^{th} available root sequence of the K available root sequences.

Further, as shown in FIG. 18, the base station 150 further includes a sending unit 1504.

The sending unit 1504 is configured to: after the determining unit 1501 determines the K available root sequences for uplink random access according to the preset policy and before the detection unit 1502 performs uplink random access detection according to the k^{th} available root sequence of the K available root sequences, send a sequence number of an initial sequence and a quantity Q of random access sequences supported by a cellular cell to the UE, where Q≧1 and Q is an integer;

The determining unit 1501 is further configured to determine an initial available root sequence in the K available root sequences according to the sequence number.

The detection unit 1502 is specifically configured to:

perform uplink random access detection according to the initial available root sequence or any one of Q−1 available root sequences after the initial available root sequence.

Further, as shown in FIG. 18, the base station 150 further includes a sending unit 1504.

The determining unit 1501 is further configured to: after the determining unit 1501 determines the K available root sequences for uplink random access according to the preset policy and before the detection unit 1502 performs uplink random access detection according to the k^{th} available root sequence of the K available root sequences, determine whether Q consecutive available root sequences exist in the K available root sequences, where Q is a quantity of random access sequences supported by a cellular cell, where 1≦Q≦K and Q is an integer.

The sending unit 1504 is configured to: if the Q consecutive available root sequences exist, send a sequence number of an initial available root sequence and a configuration message to the UE, where the sequence number of the initial available root sequence is a sequence number of the first available root sequence of the Q consecutive available root sequences, and the configuration message is used to indicate that N_{CS} supports a non-limited set and N_{CS} is configured to 0, where N_{CS} indicates a length of an uplink detection window.

Specifically, for a method for performing uplink random access by the base station 150 shown in FIG. 15 to FIG. 18, refer to the foregoing method embodiments, and details are not described in this embodiment of the present invention again.

It should be noted that in FIG. 16 to FIG. 18, units indicated by dashed lines are newly added units based on FIG. 15, and these units are optional units. This is not specifically limited in this embodiment of the present invention. Similarly, in this specification, dashed lines in the figures all indicate similar meanings, and details are not described herein again.

In the embodiments of the base station 150 shown in FIG. 15 to FIG. 18, the sending unit 1504 may be implemented by a transmitter; the determining unit 1501, the access unit, and the generation unit 1503 may be implemented by a processor. Functions of the foregoing units or steps performed by the foregoing units may be correspondingly completed by the processor. The transmitter and the processor may communicate with each other. This is not specifically limited in this embodiment of the present invention.

Because the base station 150 shown in FIG. 15 to FIG. 18 can be configured to perform the foregoing methods, for technical effects that can be achieved by the base station 150, refer to descriptions of the foregoing method embodiments, and details are not described herein again.

An embodiment of the present invention further provides UE 190. As shown in FIG. 19, the UE 190 includes: a receiving unit 1901 and an access unit 1902.

The receiving unit 1901 is configured to receive a sequence number of an initial available root sequence and a configuration message that are sent by a base station, where a maximum quantity of detection windows of single UE 190 that can be supported by the initial available root sequence is 2M+1, maximum detection windows of the single UE 190 that can be supported by the initial available root sequence do not overlap with each other, and the configuration message is used to indicate that N_{CS} supports a non-limited set and N_{CS} is configured to 0, where N_{CS} indicates a length of an uplink detection window, M>1, and M is an integer.

The access unit 1902 is configured to perform, according to the sequence number and the configuration message, random access on the initial available root sequence or any one of Q−1 consecutive available root sequences after the initial available root sequence, where a maximum quantity of detection windows of the single UE 190 that can be supported by any one of the Q−1 root sequences is 2M+1, and maximum detection windows of the single UE 190 that can be supported by any one of the Q−1 root sequences do not overlap with each other, where Q is a quantity of random access sequences supported by a cellular cell, Q≧1, and Q is an integer.

Specifically, for a method for performing uplink random access shown by the UE 190 shown in FIG. 19, refer to the foregoing method embodiments, and details are not described in this embodiment of the present invention again.

In the embodiment of the UE 190 shown in FIG. 19, the receiving unit 1901 may be implemented by a receiver; the access unit 1902 may be implemented by a processor. Functions of the foregoing units or steps performed by the foregoing units may be correspondingly completed by the processor. The receiver and the processor may communicate with each other. This is not specifically limited in this embodiment of the present invention.

Because the UE 190 shown in FIG. 19 can be configured to perform the foregoing methods, for technical effects that can be achieved by the UE 190, refer to descriptions of the foregoing method embodiments, and details are not described herein again.

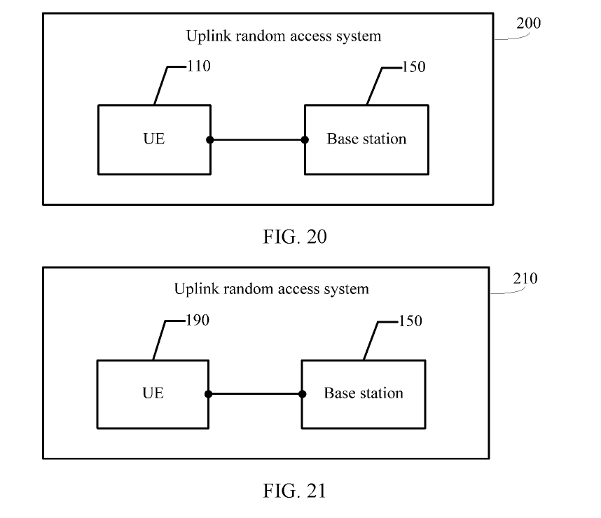

Corresponding to the foregoing method embodiments, an embodiment of the present invention further provides an uplink random access system 200. As shown in FIG. 20, the uplink random access system 200 includes the UE 110 shown in FIG. 11 to FIG. 14 and the base station 150 shown in FIG. 15 to FIG. 18.

Specifically, for a method for performing uplink random access by the uplink random access system 200 provided in this embodiment of the present invention, refer to descriptions of the foregoing method embodiments, and details are not described herein again.

Because the uplink random access system 200 provided in this embodiment of the present invention can be configured to perform the foregoing methods, for technical effects that can be achieved by the uplink random access system 200, refer to descriptions of the foregoing method embodiments, and details are not described herein again.

Corresponding to the foregoing method embodiments, an embodiment of the present invention further provides an uplink random access system 210. As shown in FIG. 21, the uplink random access system 210 includes the UE 190 shown in FIG. 19 and the base station 150 shown in FIG. 15 to FIG. 18.

Specifically, for a method for performing uplink random access by the uplink random access system 210 provided in this embodiment of the present invention, refer to descriptions of the foregoing method embodiments, and details are not described herein again.

Because the uplink random access system 210 provided in this embodiment of the present invention can be configured to perform the foregoing methods, for technical effects that can be achieved by the uplink random access system 210, refer to descriptions of the foregoing method embodiments, and details are not described herein again.

A person skilled in the art should be aware that in the foregoing one or more examples, functions described in the present invention may be implemented by hardware, software, firmware, or any combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a general-purpose or dedicated computer.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. An uplink random access method, wherein the method comprises:
determining, by user equipment UE, K available root sequences for uplink random access according to a preset policy, wherein a maximum quantity of detection windows of single UE that can be supported by each of the K available root sequences is 2M+1, and maximum detection windows of the single UE that can be supported by each available root sequence do not overlap with each other, wherein K≧1, M is a detection window parameter, M>1, and both K and M are integers; and
performing, by the UE, uplink random access according to the k^{th} available root sequence of the K available root sequences, wherein 1≦k≦K and k is an integer.

2. The method according to claim 1, wherein the preset policy comprises:
a root sequence satisfying none of the following condition A, condition B, and condition C is an available root sequence:
the condition A: any detection window m∈{−M, . . . , 0, . . . , M} of the single UE satisfies:
(m×dᵤ+N_{CS}−1)modN_{ZC}<(m×dᵤ)modN_{ZC};
the condition B: any detection windows mₐ and m_{b} of the single UE, wherein mₐ≠m_{b} and mₐ,m_{b}∈{−M, . . . 0, . . . , M}, satisfy:
(mₐ×dᵤ)modN_{ZC}≦(m_{b}×dᵤ)modN_{ZC}, and
(mₐ×dᵤ+N_{CS}−1)modN_{ZC}≧(m_{b}×dᵤ)modN_{ZC}; and
the condition C: any detection windows mₐ and m_{b} of the single UE, wherein mₐ≠m_{b} and mₐ,m_{b}∈{−M, . . . , 0, . . . , M}, satisfy:
$$( {m}_{b} \times {d}_{u} + {N}_{CS} - 1 ) mod {N}_{ZC} \geq ( {m}_{a} \times {d}_{u} ) mod {N}_{ZC} , and ( {m}_{b} \times {d}_{u} + {N}_{CS} - 1 ) mod {N}_{ZC} \leq ( {m}_{a} \times {d}_{u} + {N}_{CS} - 1 ) mod {N}_{ZC} , \\ wherein {d}_{u} = \{ \begin{matrix} p & 0 \leq p \leq {N}_{ZC} / 2 \\ {N}_{ZC} - p & others\end{matrix} ;$$
p is a minimum non-negative integer satisfying (p×u)modN_{ZC}=1; u indicates a root sequence generation parameter; a root sequence is
$${x}_{u} ( n ) = {e}^{\frac{- jun ( n + 1 )}{{N}_{ZC}}} ;$$
dᵤ indicates an offset of a peak generated when a subcarrier is shifted; N_{ZC} indicates a length of an uplink access root sequence; N_{CS} indicates a length of an uplink detection window; 2M+1 indicates the maximum quantity of detection windows of the single UE that can be supported by the available root sequence; m, mₐ, and m_{b} indicate any detection windows of the single UE; and mod indicates a modulo operation.

3. The method according to claim 1, wherein after the determining, by UE, K available root sequences for uplink random access according to a preset policy, the method further comprises:
determining, by the UE, start locations of cyclic shift sequences of the K available root sequences, wherein the start locations of the cyclic shift sequences of the K available root sequences comprise start locations of N cyclic shift sequences of the k^{th} available root sequence, the start locations of the N cyclic shift sequences comprise a start location of the n^{th} cyclic shift sequence, and N×(2M+1) detection windows corresponding to the start locations of the N cyclic shift sequences do not overlap with each other, wherein 1≦n≦N, N≧1, N indicates a quantity of cyclic shift sequences of the k^{th} available root sequence, and both n and N are integers; and
performing, by the UE, cyclic shift on the k^{th} available root sequence according to the start location of the n^{th} cyclic shift sequence, to obtain the n^{th} cyclic shift sequence of the k^{th} available root sequence, wherein magnitude of the cyclic shift is (d_{start,}_{ₙ}+a)modN_{ZC}; d_{start,}_{ₙ} is the start location of the n^{th} cyclic shift sequence; N_{ZC} indicates a length of an uplink access root sequence; mod indicates a modulo operation; and a is a preset integer value; and
the performing, by the UE, uplink random access according to the k^{th} available root sequence of the K available root sequences comprises:
performing, by the UE, uplink random access according to the k^{th} available root sequence of the K available root sequences or the n^{th} cyclic shift sequence of the k^{th} available root sequence.

4. The method according to claim 3, wherein a is prestored by the UE or is sent by a base station to the UE.

5. The method according to claim 3, wherein the start location of the n^{th} cyclic shift sequence is obtained through calculation by using the following steps:
obtaining, by the UE, a start location of a detection window of the n^{th} cyclic shift sequence according to a first formula, wherein the first formula comprises:
d_{start,}_{ₙ₁}=(d_{start,}_{ₙ}+m×dᵤ)modN_{ZC};
obtaining, by the UE, an end location of the detection window of the n^{th} cyclic shift sequence according to a second formula, wherein the second formula comprises:
$${d}_{start {,}_{n 2}} = ( {d}_{start {,}_{n}} + m \times {d}_{u} + {N}_{CS} - 1 ) mod {N}_{ZC} , \\ wherein {d}_{start {,}_{1}} = 0 ; {d}_{start {,}_{n}} = {d}_{start {,}_{n - 1}} + {N}_{CS} ;$$
$${d}_{u} = \{ \begin{matrix} p & 0 \leq p \leq {N}_{ZC} / 2 \\ {N}_{ZC} - p & others\end{matrix} ;$$
p is a minimum non-negative integer satisfying (p×u)modN_{ZC}=1; dᵤ indicates an offset of a peak generated when a subcarrier is shifted; N_{ZC} indicates a length of an uplink access root sequence; N_{CS} indicates a length of an uplink detection window; d_{start,}_{ₙ₁} indicates the start location of the detection window of the n^{th} cyclic shift sequence; and d_{start,}_{ₙ₂} indicates the end location of the detection window of the n^{th} cyclic shift sequence;
determining, by the UE for any d_{start,}_{ₗ}∈v, whether a detection window corresponding to d_{start,}_{ₙ} and a detection window corresponding to d_{start,}_{ₗ} overlap, wherein v indicates a set of start locations of detection windows, and an initial set of v is v={d_{start,l}};
if the detection window corresponding to d_{start,}_{ₙ} and the detection window corresponding to d_{start,}_{ₗ} do not overlap, determining, by the UE, that the start location of the n^{th} cyclic shift sequence is d_{start,}_{ₙ} and adding d_{start,}_{ₙ} to v; and
if the detection window corresponding to d_{start,}_{ₙ} and the detection window corresponding to d_{start,}_{ₗ} overlap, assuming d_{start,}_{ₙ}=d_{start,}_{ₙ}+1 and repeatedly performing, by the UE, the foregoing steps until d_{start,}_{ₙ}≧N_{ZC}−N_{CS}.

6. The method according to claim 5, wherein a configuration parameter is prestored by the UE or is sent by the base station to the UE, wherein the configuration parameter comprises at least one of the following parameters: M, N_{ZC}, or N_{CS}.

7. The method according to claim 1, wherein before the performing, by the UE, uplink random access according to the k^{th} available root sequence of the K available root sequences, the method further comprises:
receiving, by the UE, a physical random access channel PRACH time-frequency resource sent by the base station, wherein the PRACH time-frequency resource and a PRACH time-frequency resource that is configured by the base station for the UE when M=1 are configured independently; and
the performing, by the UE, uplink random access according to the k^{th} available root sequence of the K available root sequences comprises:
performing, by the UE, uplink random access on the PRACH according to the k^{th} available root sequence of the K available root sequences.

8. The method according to claim 1, wherein after the determining, by UE, K available root sequences for uplink random access according to a preset policy and before the performing, by the UE, uplink random access according to the k^{th} available root sequence of the K available root sequences, the method further comprises:
receiving, by the UE, a sequence number of an initial sequence and a quantity Q of random access sequences supported by a cellular cell that are sent by the base station, wherein Q≧1 and Q is an integer; and
determining, by the UE, an initial available root sequence in the K available root sequences according to the sequence number; and
the performing, by the UE, uplink random access according to the k^{th} available root sequence of the K available root sequences comprises:
performing, by the UE, uplink random access according to the initial available root sequence or any one of available root sequence of Q−1 available sequences after the initial available root sequence.

9. An uplink random access method, wherein the method comprises:
determining, by a base station, K available root sequences for uplink random access according to a preset policy, wherein a maximum quantity of detection windows of single UE that can be supported by each of the K available root sequences is 2M+1, and maximum detection windows of the single UE that can be supported by each available root sequence do not overlap with each other, wherein K≧1, M is a detection window parameter, M>1, and both K and M are integers; and
performing, by the base station, uplink random access detection according to the k^{th} available root sequence of the K available root sequences, wherein 1≦k≦K and k is an integer.

10. The method according to claim 9, wherein the preset policy comprises:
a root sequence satisfying none of the following condition A, condition B, and condition C is an available root sequence:
the condition A: any detection window m∈{−M, . . . , 0, . . . , M} of the single UE satisfies:
(m×dᵤ+N_{CS}−1)modN_{ZC}<(m×dᵤ)modN_{ZC};
the condition B: any detection windows mₐ and m_{b} of the single UE, wherein mₐ≠m_{b} and mₐ,m_{b}∈{−M, . . . , 0, . . . , M}, satisfy:
(mₐ×dᵤ)modN_{ZC}≦(m_{b}×dᵤ)modN_{ZC}; and
(mₐ×dᵤ+N_{CS}−1)modN_{ZC}≧(m_{b}×dᵤ)modN_{ZC}; and
the condition C: any detection windows mₐ and m_{b} of the single UE, wherein mₐ≠m_{b} and mₐ,m_{b}∈{−M, . . . , 0, . . . , M}, satisfy:
$$( {m}_{b} \times {d}_{u} + {N}_{CS} - 1 ) mod {N}_{ZC} \geq ( {m}_{a} \times {d}_{u} ) mod {N}_{ZC} , and ( {m}_{b} \times {d}_{u} + {N}_{CS} - 1 ) mod {N}_{ZC} \leq ( {m}_{a} \times {d}_{u} + {N}_{CS} - 1 ) mod {N}_{ZC} , \\ wherein {d}_{u} = \{ \begin{matrix} p & 0 \leq p \leq {N}_{ZC} / 2 \\ {N}_{ZC} - p & others\end{matrix} ;$$
p is a minimum non-negative integer satisfying (p×u)modN_{ZC}=1; u indicates a root sequence generation parameter; a root sequence is
$${x}_{u} ( n ) = {e}^{\frac{- jun ( n + 1 )}{{N}_{ZC}}} ;$$
dᵤ indicates an offset of a peak generated when a subcarrier is shifted; N_{ZC} indicates a length of an uplink access root sequence; N_{CS} indicates a length of an uplink detection window; 2M+1 indicates the maximum quantity of detection windows of the single UE that can be supported by the available root sequence; m, mₐ, and m_{b} indicate any detection windows of the single UE; and mod indicates a modulo operation.

11. The method according to claim 9, wherein after the determining, by a base station, K available root sequences for uplink random access according to a preset policy, the method further comprises:
determining, by the base station, start locations of cyclic shift sequences of the K available root sequences, wherein the start locations of the cyclic shift sequences of the K available root sequences comprise start locations of N cyclic shift sequences of the k^{th} available root sequence, the start locations of the N cyclic shift sequences comprise a start location of the n^{th} cyclic shift sequence, and N×(2M+1) detection windows corresponding to the start locations of the N cyclic shift sequences do not overlap with each other, wherein 1≦n≦N, N≧1, N indicates a quantity of cyclic shift sequences of the k^{th} available root sequence, and both n and N are integers; and
performing, by the base station, cyclic shift on the k^{th} available root sequence according to the start location of the n^{th} cyclic shift sequence, to obtain the n^{th} cyclic shift sequence of the k^{th} available root sequence, wherein magnitude of the cyclic shift is (d_{start,}_{ₙ}+a)modN_{ZC}, d_{start,}_{ₙ} is the start location of the n^{th} cyclic shift sequence; N_{ZC} indicates a length of an uplink access root sequence; mod indicates a modulo operation; and a is a preset integer value; and
the performing, by the base station, uplink random access detection according to the k^{th} available root sequence of the K available root sequences comprises:
performing, by the base station, uplink random access detection according to the k^{th} available root sequence of the K available root sequences or the n^{th} cyclic shift sequence of the k^{th} available root sequence.

12. The method according to claim 11, wherein the start location of the n^{th} cyclic shift sequence is obtained through calculation by using the following steps:
obtaining, by the base station, a start location of a detection window of the n^{th} cyclic shift sequence according to a first formula, wherein the first formula comprises:
d_{start,}_{ₙ₁}=(d_{start,}_{ₙ}+m×dᵤ)modN_{ZC};
obtaining, by the UE, an end location of the detection window of the n^{th} cyclic shift sequence according to a second formula, wherein the second formula comprises:
$${d}_{start {,}_{n 2}} = ( {d}_{start {,}_{n}} + m \times {d}_{u} + {N}_{CS} - 1 ) mod {N}_{ZC} , \\ wherein {d}_{start {,}_{1}} = 0 ; {d}_{start {,}_{n}} = {d}_{start {,}_{n - 1}} + {N}_{CS} ;$$
$${d}_{u} = \{ \begin{matrix} p & 0 \leq p \leq {N}_{ZC} / 2 \\ {N}_{ZC} - p & others\end{matrix} ;$$
p is a minimum non-negative integer satisfying (p×u)modN_{ZC}=1; dᵤ indicates an offset of a peak generated when a subcarrier is shifted; N_{ZC} indicates a length of an uplink access root sequence; N_{CS} indicates a length of an uplink detection window; d_{start,}_{ₙ₁} indicates the start location of the detection window of the n^{th} cyclic shift sequence; and d_{start,}_{ₙ₂} indicates the end location of the detection window of the n^{th} cyclic shift sequence;
determining, by the UE for any d_{start,}_{ₗ}∈v, whether a detection window corresponding to d_{start,}_{ₙ} and a detection window corresponding to d_{start,}_{ₙ} overlap, wherein v indicates a set of start locations of detection windows, and an initial set of v is v={d_{start,l}};
if the detection window corresponding to d_{start,}_{ₙ} and the detection window corresponding to d_{start,}_{ₗ} do not overlap, determining, by the UE, that the start location of the n^{th} cyclic shift sequence is d_{start,}_{ₙ} and adding d_{start,}_{ₙ} to v; and
if the detection window corresponding to d_{start,}_{ₙ} and the detection window corresponding to d_{start.}_{ₗ} overlap, assuming d_{start,}_{ₙ}=d_{start,}_{ₙ}+1 and repeatedly performing, by the UE, the foregoing steps until d_{start,}_{ₙ}≧N_{ZC}−N_{CS}.

13. The method according to claim 9, wherein before the performing, by the base station, uplink random access detection according to the k^{th} available root sequence of the K available root sequences, the method further comprises:
sending, by the base station, a physical random access channel PRACH time-frequency resource to user equipment UE, wherein the PRACH time-frequency resource and a PRACH time-frequency resource that is configured by the base station for the UE when M=1 are configured independently; and
the performing, by the base station, uplink random access detection according to the k^{th} available root sequence of the K available root sequences comprises:
performing, by the base station, uplink random access detection on the PRACH according to the k^{th} available root sequence of the K available root sequences.

14. The method according to claim 9, wherein after the determining, by a base station, K available root sequences for uplink random access according to a preset policy and before the performing, by the base station, uplink random access detection according to the k^{th} available root sequence of the K available root sequences, the method further comprises:
sending, by the base station, a sequence number of an initial sequence and a quantity Q of random access sequences supported by a cellular cell to the UE, wherein Q≧1 and Q is an integer; and
determining, by the base station, an initial available root sequence in the K available root sequences according to the sequence number; and
the performing, by the base station, uplink random access detection according to the k^{th} available root sequence of the K available root sequences comprises:
performing, by the base station, uplink random access detection according to the initial available root sequence or any one of Q−1 available root sequences after the initial available root sequence.

15. The method according to claim 9, wherein after the determining, by a base station, K available root sequences for uplink random access according to a preset policy and before the performing, by the base station, uplink random access detection according to the k^{th} available root sequence of the K available root sequences, the method further comprises:
determining, by the base station, whether Q consecutive available root sequences exist in the K available root sequences, wherein Q is a quantity of random access sequences supported by a cellular cell, 1≦Q≦K, and Q is an integer; and
if the Q consecutive available root sequences exist, sending, by the base station, a sequence number of an initial available root sequence and a configuration message to the UE, wherein the sequence number of the initial available root sequence is a sequence number of the first available root sequence of the Q consecutive available root sequences, and the configuration message is used to indicate that N_{CS} supports a non-limited set and N_{CS} is configured to 0, wherein N_{CS} indicates a length of an uplink detection window.

16. A device, comprising:
a processor; and
a non-transitory memory, wherein the memory stores an execution instruction; and when the processor executes the execution instruction to enable the device to perform the following steps:
determining K available root sequences for uplink random access according to a preset policy, wherein a maximum quantity of detection windows of single UE that can be supported by each of the K available root sequences is 2M+1, and maximum detection windows of the single UE that can be supported by each available root sequence do not overlap with each other, wherein K≧1, M is a detection window parameter, M>1, and both K and M are integers; and
performing uplink random access according to the k^{th} available root sequence of the K available root sequences, wherein 1≦k≦K and k is an integer.

17. The device according to claim 1, wherein the preset policy comprises:
a root sequence satisfying none of the following condition A, condition B, and condition C is an available root sequence:
the condition A: any detection window m∈{−M, . . . , 0, . . . , M} of the single UE satisfies:
(m×dᵤ+N_{CS}−1)modN_{ZC}<(m×dᵤ)modN_{ZC};
the condition B: any detection windows mₐ and m_{b} of the single UE, wherein mₐ≠m_{b} and mₐ,m_{b}∈{−M, . . . , 0, . . . , M}, satisfy:
(mₐ×dᵤ)modN_{ZC}≦(m_{b}×dᵤ)modN_{ZC}; and
(mₐ×dᵤ+N_{CS}−1)modN_{ZC}≧(m_{b}×dᵤ)modN_{ZC}; and
the condition C: any detection windows mₐ and m_{b} of the single UE, wherein mₐ≠m_{b} and mₐ,m_{b}∈{−M, . . . , 0, . . . , M}, satisfy:
$$( {m}_{b} \times {d}_{u} + {N}_{CS} - 1 ) mod {N}_{ZC} \geq ( {m}_{a} \times {d}_{u} ) mod {N}_{ZC} , and ( {m}_{b} \times {d}_{u} + {N}_{CS} - 1 ) mod {N}_{ZC} \leq ( {m}_{a} \times {d}_{u} + {N}_{CS} - 1 ) mod {N}_{ZC} , \\ wherein {d}_{u} = \{ \begin{matrix} p & 0 \leq p \leq {N}_{ZC} / 2 \\ {N}_{ZC} - p & others\end{matrix} ;$$
p is a minimum non-negative integer satisfying (p×u)modN_{ZC}=1; u indicates a root sequence generative parameter; a root sequence is
$${x}_{u} ( n ) = {e}^{\frac{- jun ( n + 1 )}{{N}_{ZC}}} ;$$
dᵤ indicates an offset of a peak generated when a subcarrier is shifted; N_{ZC} indicates a length of an uplink access root sequence; N_{CS} indicates a length of an uplink detection window; 2M+1 indicates the maximum quantity of detection windows of the single UE that can be supported by the available root sequence; m, mₐ, and m_{b} indicate any detection windows of the single UE; and mod indicates a modulo operation.

18. The device according to claim 1, wherein after the determining K available root sequences for uplink random access according to a preset policy, the method further comprises:
determining start locations of cyclic shift sequences of the K available root sequences, wherein the start locations of the cyclic shift sequences of the K available root sequences comprise start locations of N cyclic shift sequences of the k^{th} available root sequence, the start locations of the N cyclic shift sequences comprise a start location of the n^{th} cyclic shift sequence, and N×(2M+1) detection windows corresponding to the start locations of the N cyclic shift sequences do not overlap with each other, wherein 1≦n≦N, N≧1, N indicates a quantity of cyclic shift sequences of the k^{th} available root sequence, and both n and N are integers; and
performing cyclic shift on the k^{th} available root sequence according to the start location of the n^{th} cyclic shift sequence, to obtain the n^{th} cyclic shift sequence of the k^{th} available root sequence, wherein magnitude of the cyclic shift is (d_{start,}_{ₙ}+a)modN_{ZC}; d_{start,}_{ₙ} is the start location of the n^{th} cyclic shift sequence; N_{ZC} indicates a length of an uplink access root sequence; mod indicates a modulo operation; and a is a preset integer value; and
the performing uplink random access according to the k^{th} available root sequence of the K available root sequences comprises:
performing uplink random access according to the k^{th} available root sequence of the K available root sequences or the n^{th} cyclic shift sequence of the k^{th} available root sequence.

19. The device according to claim 3, wherein a is prestored by the device or is sent by a base station to the device.

20. The device according to claim 3, wherein the start location of the n^{th} cyclic shift sequence is obtained through calculation by using the following steps:
obtaining a start location of a detection window of the n^{th} cyclic shift sequence according to a first formula, wherein the first formula comprises:
d_{start,}_{ₙ₁}=(d_{start,}_{ₙ}+m×dᵤ)modN_{ZC};
obtaining an end location of the detection window of the n^{th} cyclic shift sequence according to a second formula, wherein the second formula comprises:
$${d}_{start {,}_{n 2}} = ( {d}_{start {,}_{n}} + m \times {d}_{u} + {N}_{CS} - 1 ) mod {N}_{ZC} , \\ wherein {d}_{start {,}_{1}} = 0 ; {d}_{start {,}_{n}} = {d}_{start {,}_{n - 1}} + {N}_{CS} ;$$
$${d}_{u} = \{ \begin{matrix} p & 0 \leq p \leq {N}_{ZC} / 2 \\ {N}_{ZC} - p & others\end{matrix} ;$$
p is a minimum non-negative integer satisfying (p×u)modN_{ZC}=1; dᵤ indicates an offset of a peak generated when a subcarrier is shifted; N_{ZC} indicates a length of an uplink access root sequence; N_{CS} indicates a length of an uplink detection window; d_{start,}_{ₙ₁} indicates the start location of the detection window of the n^{th} cyclic shift sequence; and d_{start,}_{ₙ₂} indicates the end location of the detection window of the n^{th} cyclic shift sequence;
determining for any d_{start,}_{ₗ}∈v, whether a detection window corresponding to d_{start,}_{ₙ} and a detection window corresponding to d_{start,}_{ₗ} overlap, wherein v indicates a set of start locations of detection windows, and an initial set of v is v={d_{start,l}};
if the detection window corresponding to d_{start,}_{ₙ} and the detection window corresponding to d_{start,}_{ₗ} do not overlap, determining, by the UE, that the start location of the n^{th} cyclic shift sequence is d_{start,}_{ₙ} and adding d_{start,}_{ₙ} to v; and
if the detection window corresponding to d_{start,}_{ₙ} and the detection window corresponding to d_{start,}_{ₗ} overlap, assuming d_{start,}_{ₙ}=d_{start,}_{ₙ}+1 and repeatedly performing, by the UE, the foregoing steps until d_{start,}_{ₙ}≧N_{ZC}−N_{CS}.
